(19) United States
(12) Patent Application Publication
(10) Pub. No.: US 2024/0059106 A1
(43) Pub. Date: Feb. 22, 2024

(54) TIRE INFLATION SYSTEM

(71) Applicant: Consolidated Metco, Inc., Vancouver, WA (US)

(72) Inventors: Richard T. Caminari, Vancouver, WA (US); Jared Wiley Richard Burris, Ridgefield, WA (US); Randy P. Smith, Clackamas, OR (US); Jonathan Roy Elkin, Camas, WA (US); Connor Regan, Vancouver, WA (US)

(21) Appl. No.: 18/235,568

(22) Filed: Aug. 18, 2023

Related U.S. Application Data
(60) Provisional application No. 63/399,375, filed on Aug. 19, 2022.

(51) Int. Cl. B60C 23/00

(52) U.S. Cl. CPC B60C 23/00318; B60C 23/00363

(57) ABSTRACT

In one aspect, a rotary union for a wheel end system including a wheel hub having a passageway. The rotary union includes a pressurized air receiver configured to be mounted to a vehicle spindle, an air inlet of the pressurized air receiver, a pressurized air distributor rotatable around an axis relative to the pressurized air receiver, and an air outlet of the pressurized air distributor. The pressurized air distributor is configured to be mounted to the wheel hub and rotate therewith. The rotary union further includes a seal axially spaced from the air inlet so that the seal and the air inlet are offset from one another along with the vehicle spindle. The seal is shiftable from a disengaged configuration to an engaged configuration to permit pressurized air received at the air inlet of the pressurized air receiver to flow to the air outlet of the pressurized air distributor.

### CROSS-REFERENCE TO RELATED APPLICATION

This application claims the benefit of U.S. Provisional Application No. 63/399,375, filed Aug. 19, 2022, which is hereby incorporated herein by reference in its entirety.

### FIELD

This disclosure relates to vehicles and, more specifically, to tire inflation systems for vehicles.

### BACKGROUND

Tires for vehicles are designed to operate at a predetermined internal pressure. Inadequate tire pressure is a primary cause of tire wear and failure for various types of vehicles. Commercial vehicles, such as class seven or higher as described by the U.S. Federal Highway Administration (FHWA), utilize large tires to support heavy loads carried by the commercial vehicles. Commercial vehicles may include, for example, tractors (sometimes referred to as semi-truck), trailers, and heavy trucks.

Tire pressure maintenance is a known problem within the commercial vehicle industry because a significant maintenance expense for commercial vehicle fleets is the cost of tires. Tire pressure maintenance is especially problematic for fleets of tractor-trailers, where each tractor may have two steering tires and eight drive tires and each trailer may have eight tires.

There are several approaches currently for addressing tire underinflation of trailer tires. One automatic tire inflation system utilizes a small air seal that receives pressurized air provided through the center of the trailer axle. The pressurized air is then routed from the air seal to a hubcap of the associated wheel and, ultimately, to the tire of the wheel. While the vehicle's pneumatic system is running, the automatic tire inflation system constantly applies air to the tire at a set pressure to keep the tire at a minimum tire pressure.

Drive axles of tractors or other commercial vehicles include a spindle with a half-shaft extending in the spindle. A drive wheel hub is mounted to the spindle and a drive flange of the half-shaft is secured to an outboard end of the drive wheel hub by way of studs of the wheel hub. The presence of the rotating half-shaft in the spindle and the drive flange secured to the outboard end of the drive hub precludes the use of conventional tire inflation systems that route pressurized air through the spindle to a hubcap of the wheel.

U.S. Pat. No. 11,254,170 discloses an automatic tire inflation system with thru-hub air feed. The automatic tire inflation system includes a spindle having a channel formed therein that receives pressurized air. The spindle channel directs the pressurized air radially outward into a grease pocket between bearings of a unitized bearing that connects a wheel hub to the spindle. A rotary air seal enables the flow of pressurized air from the channel of the spindle to a channel of the wheel hub. However, the automatic tire inflation system of the '170 patent requires a specialized vehicle spindle that includes the channel to receive pressurized air. The channel in the spindle may present difficulties in forming the channel in the side wall of the spindle. Another issue with the system of the '170 patent is that positioning the rotary air seal in the grease pocket exposes the rotary air seal to potential failure modes associated with debris in the grease pocket and oil foaming. Further, leakage of air from the rotary air seal may result in pressurizing an oil seal of the wheel hub and associated damage and/or oil leakage.

### SUMMARY

In one aspect of the present disclosure, a rotary union is provided for a wheel end system including a wheel hub having a passageway. The rotary union includes a pressurized air receiver configured to be mounted to a vehicle spindle and having an air inlet of the pressurized air receiver. The rotary union further includes a pressurized air distributor rotatable around an axis relative to the pressurized air receiver. The pressurized air distributor is configured to be mounted to a wheel hub and rotate therewith. The pressurized air distributor has an air outlet to direct pressurized air toward the passageway of the wheel hub. The pressurized air receiver and the pressurized air distributor have a seal axially spaced from the air inlet of the pressurized air receiver so that the seal and the air inlet are offset from one another along the vehicle spindle with the pressurized air receiver mounted to the vehicle spindle and the pressurized air distributor mounted to the wheel hub. The seal is shiftable from a disengaged configuration to an engaged configuration to permit pressurized air received at the air inlet of the pressurized air receiver to flow to the air outlet of the pressurized air distributor. Because the pressurized air receiver is configured to be mounted to a vehicle spindle, the rotary union may be mounted to the spindle of a vehicle and provide an interface for routing pressurized air between a vehicle pressurized air supply and the passageway of the rotatable wheel hub.

In another aspect of the present disclosure, a wheel hub is provided that includes a wheel hub body and inboard and outboard bearings to rotatably mount the wheel hub body to a vehicle spindle. The wheel hub includes a pressurized air passageway associated with the wheel hub body that is rotatable with the wheel hub body about the vehicle spindle. The wheel hub further includes a rotary union inboard of the inboard bearing. The rotary union has an air inlet to receive pressurized air and an air outlet to direct the pressurized air toward the pressurized air passageway. The air outlet is rotatable with the wheel hub body about the vehicle spindle. The rotary union has a seal operable to pneumatically connect and disconnect the air inlet and the air outlet of the rotary union. In this manner, the wheel hub provides a rotary union operable to selectively establish a pressurized air flowpath while being inboard of the inboard bearing and lubricant thereof which may keep the lubricant of the inboard bearing from fouling the seal of the rotary union.

The present disclosure also provides a diaphragm seal. The diaphragm seal includes an annular diaphragm having a recess to receive pressurized air and an air outlet of the diaphragm to permit pressurized air to flow out of the diaphragm. The diaphragm has a contact portion configured to shift in a first radial direction toward a sealing surface in response to the recess receiving the pressurized air. The contact portion is configured to shift in an opposite, second radial direction away from the sealing surface upon the pressurized air no longer being provided to the recess of the diaphragm. The contact portion has a protrusion configured to engage the sealing surface upon the contact portion shifting in the first radial direction. The protrusion of the diaphragm concentrates the pressure force from the pressurized air in the recess of the diaphragm to securely seal the diaphragm against the sealing surface. Further, the diaphragm seal permits an associated system to control the engagement or disengagement of the diaphragm with the sealing surface by applying or not applying pressurized air to the recess of the diaphragm.

### BRIEF DESCRIPTION OF THE DRAWINGS

FIG. 1 is a perspective view of a wheel end system of a commercial vehicle including a wheel hub mounted to a spindle;

FIG. 2 is a cross-sectional view taken across line 2-2 in FIG. 1 showing an air seal cartridge inboard of an inboard bearing assembly of the wheel hub, the wheel hub having a wheel hub body with a passageway for directing air from the air seal cartridge to an exterior port of the wheel hub;

FIG. 3 is a perspective view of the air seal cartridge of FIG. 2 showing a radially inner, non-rotatable pressurized air receiver having an inlet for pressurized air and a radially outer, rotatable pressurized air distributor that directs pressurized air to the passageway of the wheel hub;

FIG. 4 is an enlarged view of the areas in dashed in FIG. 2 showing a diaphragm seal of the air seal cartridge in a disengaged configuration;

FIG. 5 is a view similar to FIG. 4 showing the diaphragm seal in an engaged configuration and air flowing from the non-rotatable pressurized air receiver to the rotatable pressurized air distributor and into the wheel hub passageway;

FIG. 6 is a perspective view of the non-rotatable pressurized air receiver of FIG. 5 showing a diffuser ring having an opening flanked on either side thereof by a diaphragm member with a ridge to engage a sealing ring of the rotatable pressurized air distributor;

FIG. 7 is a perspective view of another air seal cartridge having a non-rotatable air receiver with an air inlet to receive pressurized air and a rotatable air distributor having an air outlet to direct pressurized air into a wheel hub passageway;

FIG. 8 is a cross-sectional view of the air seal cartridge of FIG. 7 installed between a wheel hub and a spindle, FIG. 8 showing a face seal of the air seal cartridge in a disengaged configuration;

FIG. 9 is a cross-sectional view similar to FIG. 8 showing the face seal in an engaged configuration and air flowing from the non-rotatable pressurized air receiver of the air seal cartridge, into a rotatable pressurized air distributor of the air seal cartridge, and into a passageway of the wheel hub;

FIG. 10 is a cross-sectional, perspective view of the non-rotatable pressurized air receiver of FIG. 9 showing a channel formed between a sealing member and a seal ring that receives a rotatable sealing member of the rotatable pressurized air distributor;

FIG. 11 is a schematic view of a tire pressure system in accordance with one embodiment of the present disclosure;

FIG. 12 is a flow diagram of a method of operating the tire pressure system of FIG. 11 including parameters, conditions, and responses associated with the method;

FIG. 13 is a flow diagram of a method of operating the tire pressure system of FIG. 11;

FIG. 14 is a cross-sectional view of another embodiment of a diaphragm seal in disengaged configuration;

FIG. 15 is a cross-sectional view showing the diaphragm seal of FIG. 14 in an engaged configuration;

FIG. 16 is a cross-sectional view of another embodiment of a diaphragm seal in a disengaged configuration;

FIG. 17 is a cross-sectional view showing the diaphragm seal of FIG. 16 in an engaged configuration;

FIG. 18 is a cross-sectional view of an air seal cartridge having a lip seal;

FIG. 19 is a cross-sectional view of an air seal cartridge having a lip seal;

FIG. 20 is a cross-sectional view of an air seal cartridge having a lip seal;

FIG. 21 is a cross-sectional view of an air seal cartridge having a diaphragm seal;

FIG. 22 is a cross-sectional view of a diaphragm seal in a disengaged configuration with the diaphragm spaced from a sealing surface;

FIGS. 23-26 are cross-sectional views of the diaphragm seal of FIG. 22 as pressurized air is applied to a chamber of the diaphragm seal and a diaphragm of the diaphragm seal engages the sealing surface;

FIG. 27 is a cross-sectional view of the diaphragm seal of FIG. 22 showing the diaphragm seal at a temperature of 300° F. and in a disengaged configuration;

FIGS. 28-31 are cross-sectional views of the diaphragm seal of FIG. 27 showing the chamber of the diaphragm seal receiving pressurized air and the diaphragm engaging the sealing surface;

FIG. 32 is a cross-sectional view of the diaphragm seal of FIG. 22 showing the diaphragm seal at a temperature of −40° F. and in a disengaged configuration;

FIG. 33 is a cross-sectional view of an air seal cartridge having a diaphragm seal; and

FIG. 34 is a perspective view of a diaphragm of the air seal cartridge of FIG. 33 showing a nozzle of a diaphragm.

### DETAILED DESCRIPTION

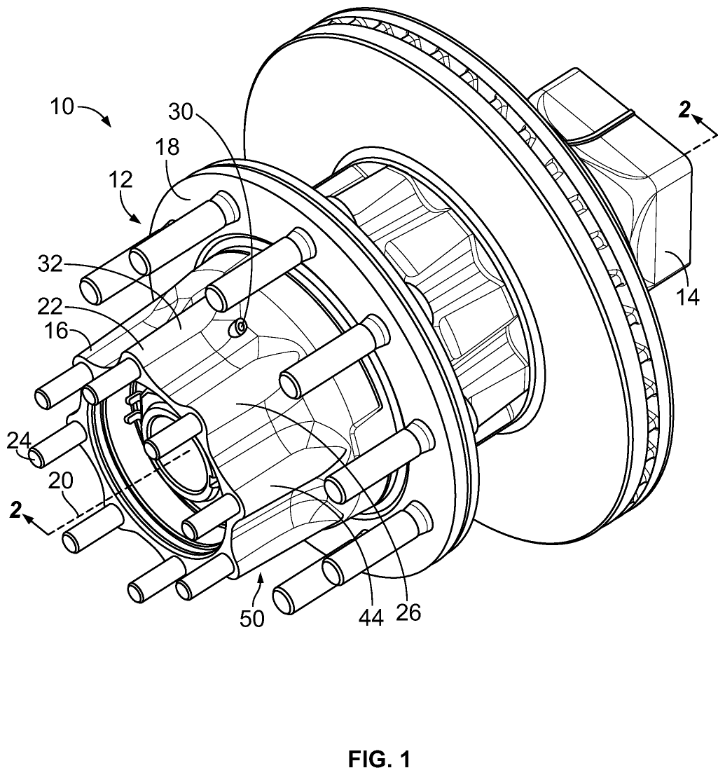

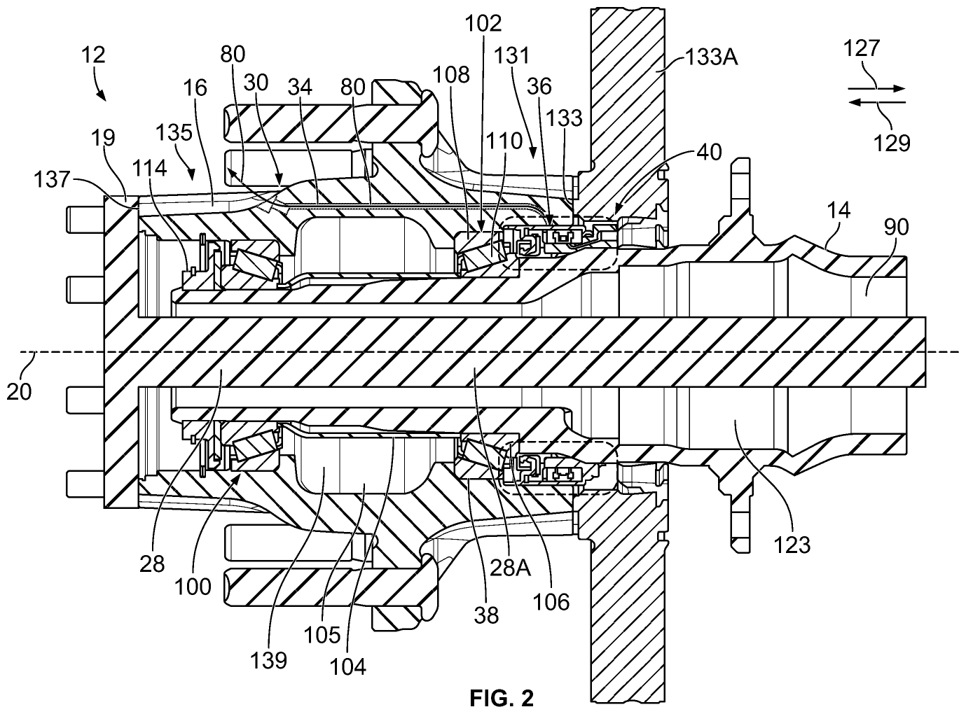

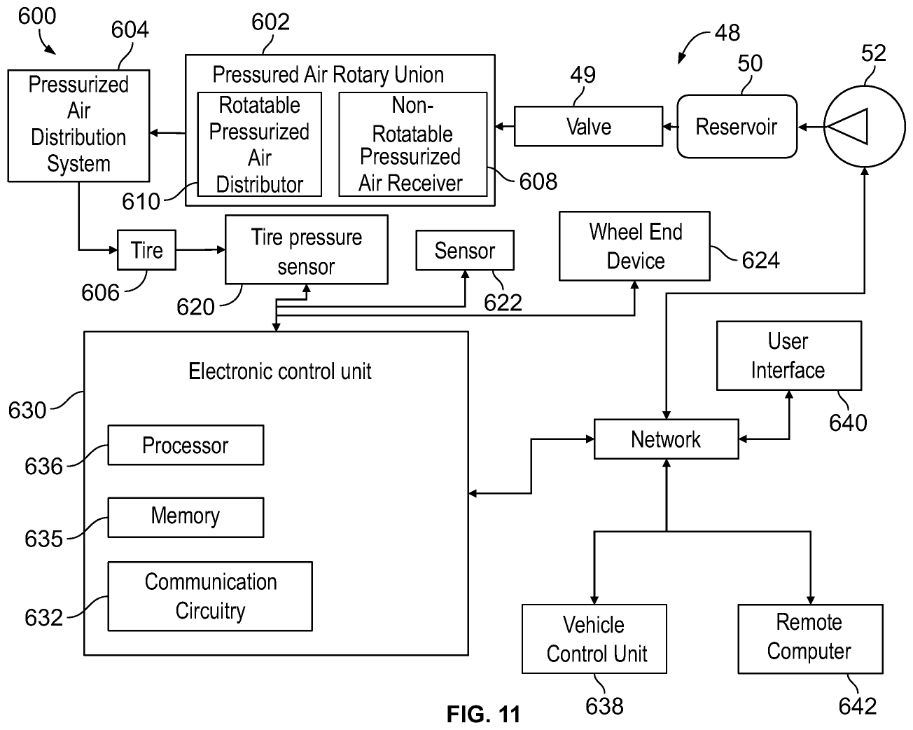

With reference to FIGS. 1 and 11, a tire inflation system 600 is provided that includes a wheel end system 10 having a wheel hub assembly 12 mounted to a spindle 14. The wheel hub assembly 12 includes a wheel hub body 16 having a mounting portion, such as a mounting flange 18, configured to have a wheel mounted thereto. The mounting flange 18 may include studs to fit into openings of the wheel or openings to receive studs of a wheel, as some examples. The wheel hub body 16 and wheel mounted thereto are rotatable around a central axis 20 of the wheel hub assembly 12. The wheel hub assembly 12 is for a drive wheel of a vehicle and includes axle stud bosses 22 that support axle studs 24 of the wheel hub assembly 12. The axle studs 24 extend through openings of a drive flange 26 (see FIG. 2) of a drive axle shaft, such as a half-shaft 28. Upon rotation of the half-shaft 28, the engagement between the axle studs 24 and the drive flange 26 causes rotation of the wheel hub body 16 around the central axis 20.

As shown in FIGS. 1 and 2, the wheel hub body 16 includes a passageway 34 having an exterior port, such as outlet port 30, at an exterior surface 32 of the wheel hub body 16. The passageway 34 further includes an interior port, such as inlet port 36, at an interior surface 38 of the wheel hub body 16. With reference to FIG. 2, the wheel hub assembly 12 includes a rotary union such as an air seal cartridge 40. The air seal cartridge 40 receives pressurized air from a vehicle pressurized air supply 48 (see FIG. 11) and communicates the pressurized air to the passageway 34 of the wheel hub body 16. The passageway 34 directs the pressurized air to an air distribution system 604, such as one more tubes, valves, and/or fittings that conduct the pressurized air to a tire 606 of the associated wheel.

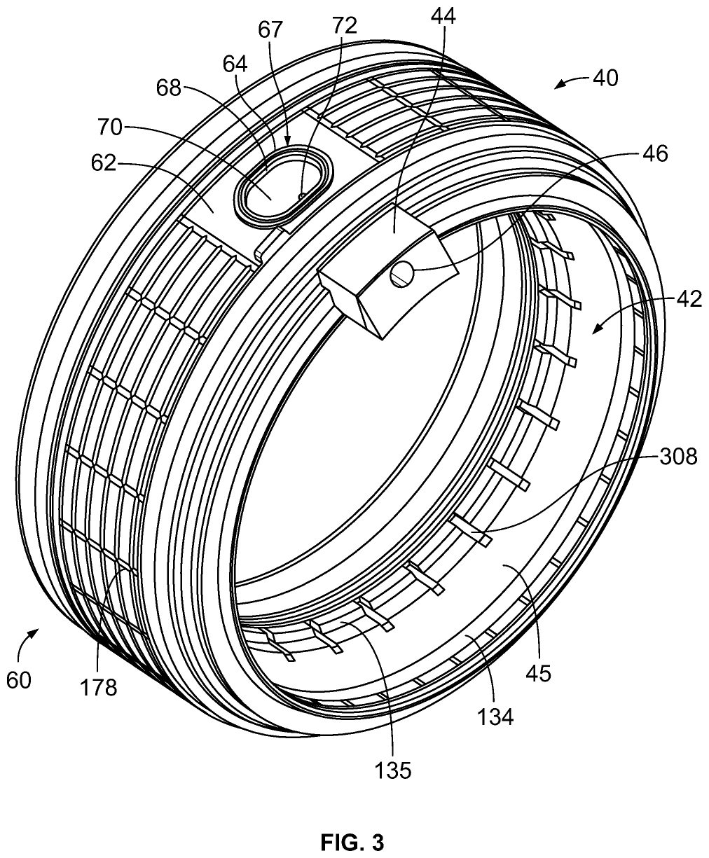

With reference to FIGS. 2 and 3, the air seal cartridge 40 includes a wheel end pressurized air supply, such as a non-rotatable pressurized air receiver 42 mounted to the spindle 14 and a rotatable pressurized air distributor 60 mounted to the wheel hub body 16. As used herein, the term “rotatable” is intended to refer to a component that rotates with rotation of an associated wheel during normal operation of the vehicle and the term “non-rotatable” is intended to refer to a component that does not rotate with rotation of the associated wheel during normal operation of the vehicle.

The non-rotatable pressurized air receiver 42 has a body 44 with a central opening 45 to receive the spindle 14. The body 44 has an air inlet 46 that receives pressurized air from the vehicle pressurized air supply 48 (see FIG. 11). The vehicle pressurized air supply 48 may include, for example, a valve 49 operatively connected to the air inlet 46, a reservoir 50, and a pump 52. The pump 52 pressurizes air in the reservoir 50 and the valve 49 is opened to permit pressurized air to flow into the air inlet 46 of the non-rotatable pressurized air receiver 42.

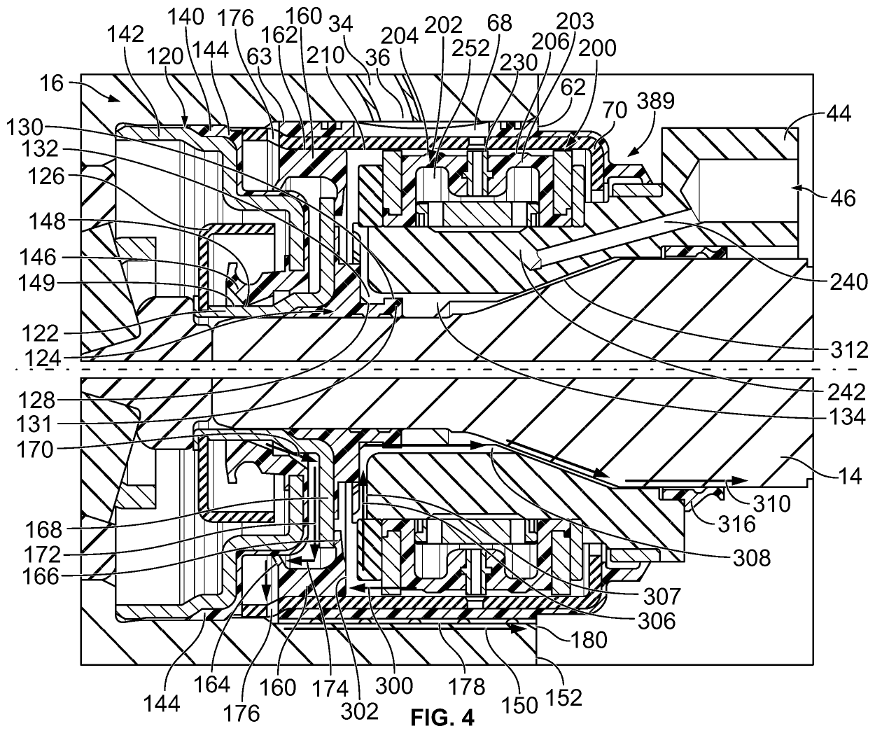

As discussed in greater detail below, air seal cartridge 40 includes a seal, such as a diaphragm seal 200 (see FIG. 4), having an engaged configuration wherein the diaphragm seal 200 permits pressurized air applied to the air inlet 46 to flow to the wheel hub passage 36 and a disengaged configuration wherein the diaphragm seal 200 limits contact between portions of the diaphragm seal 200. In one embodiment, the diaphragm seal 200 has rotatable and non-rotatable components that contact one another to form a pressurized air flow path when the diaphragm seal 200 is pressurized and are in clearance with one another when the diaphragm seal 200 is unpressurized.

The diaphragm seal 200 shifts from the disengaged configuration to the engaged configuration upon pressurized air being applied to the air inlet 46. The vehicle includes an electronic control unit, such as electronic control unit 630 (see FIG. 11) that opens the valve 49 to direct pressurized air to the air inlet 46 or closes the valve 49 to inhibit the flow of pressurized air to the air inlet 46. The electronic control unit 630 opens the valve 49 upon satisfaction of one or more conditions, such as a tire underinflation condition being satisfied (e.g., tire pressure being below a predetermined tire pressure) and a vehicle velocity condition being satisfied (e.g., a vehicle velocity being below a predetermined vehicle velocity). In one embodiment, the electronic control unit 630 opens the valve 49 and shifts the diaphragm seal 200 from the disengaged configuration to the engaged configuration when the tire pressure of the tire 606 is below the predetermined tire pressure and when the vehicle is stationary. By shifting the diaphragm seal 200 to the engaged configuration when the vehicle is stationary, the friction between components of the diaphragm seal 200 is limited which improves the durability of the diaphragm seal 200.

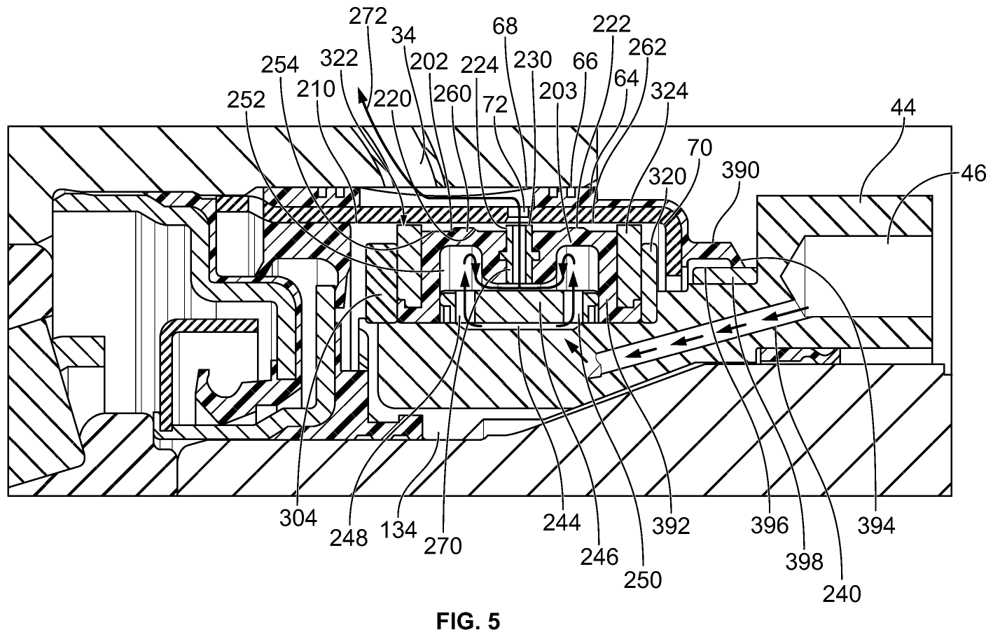

Returning to FIG. 3, the rotatable pressurized air distributor 60 is configured to be mounted to the interior surface 38 of the wheel hub body 16 and rotate with the wheel hub body 16 about the central axis 20. The rotatable pressurized air distributor 60 has a pressurized air outlet 67 configured to direct pressurized air into the passageway 67 of the wheel hub body 16. The rotatable pressurized air distributor 60 has a sleeve mount 62, which may be made of a polymer such as a rubber, for engaging a radially inner surface 63 (see FIG. 4) of the wheel hub body 16. The sleeve mount 62 has one or more sealing members, such as ridges 64 (see FIG. 5) spaced apart by grooves 66, extending about an opening 68 of the sleeve mount 62 that is radially aligned with the interior port 36 of the passageway 34. The ridges 64 form a seal with the radially inner surface 63 of the wheel hub body 16 to inhibit air leakage between the sleeve mount 62 and the wheel hub body 16.

The rotatable pressurized air distributor 60 further includes a seal sleeve 70 that may be made of a metallic material. In one embodiment, the sleeve mount 62 is molded on the seal sleeve 70. The seal sleeve 70 has an outlet opening 72 that opens to the opening 68 of the sleeve mount 62. As discussed in greater detail below, when the diaphragm seal 200 is in the sealing or engaged configuration, pressurized air received at the air inlet 46 of the non-rotatable pressurized air receiver 42 is directed through the outlet opening 72 of the seal sleeve 70, through the opening 68 of the sleeve mount 62, and into the passageway 34. The pressurized air travels in direction 80 (see FIG. 2) through the passageway 34 to the exterior port 30. In one embodiment, the air distribution system 604 includes a fitting engaged with the exterior port 30 and a tube that connects the fitting to a one-way valve of the tire 606. In this manner, the air seal cartridge 40 may communicate pressurized air to a tire of a wheel mounted to the wheel hub assembly 12 despite the drive half-shaft 28 extending in an interior 90 of the spindle 14.

With reference to FIG. 2, the wheel hub assembly 12 includes an outboard bearing such as outboard bearing assembly 100, an inboard bearing such as inboard bearing assembly 102, a spacer 104, and a grease pocket 105. Each of the inboard and outboard bearing assemblies 100, 102 includes a cone 106, a cup 108, and bearing elements such as rollers 110 that roll along races of the cone 106 and cup 108. In one embodiment, lubricant is permitted to flow from an interior 123 of the spindle 14 into contact with the inboard and outboard bearing assemblies 102, 108. An inboard lubricant seal 120 (see FIG. 4) inhibits inboard flow of lubricant from the inboard bearing assembly 102. In this manner, the inboard lubricant seal 120 keeps the air seal cartridge 40 free of lubricant from the inboard bearing assembly 102. The lubricant may include, for example, oil or grease.

The wheel hub system 12 further includes a spindle lock nut 114 to secure the wheel hub system 12 to the spindle 14. Specifically, the spindle lock nut 114 has threads to engage threads of the spindle 14. The spindle lock nut 114 is tightened onto the spindle 104 to urge the inboard and outboard bearing assemblies 102, 108, spacer 104, and the air seal cartridge in an inboard direction 127. In this manner, the wheel hub assembly 12 may be mounted on the spindle 14 by positioning the wheel hub assembly 12 on the spindle 14 and tightening the spindle lock nut 114 to secure the wheel hub assembly 12 to the spindle 14. Once the wheel hub assembly 12 has been mounted on the spindle 14, a shaft portion 28A of the half-shaft 28 is advanced in the inboard direction 127 into the interior 123 of the spindle 14 and the drive flange 26 of the half-shaft 28 is connected to the axle studs 24. In one embodiment, the spindle lock nut 114 includes a retainer assembly that inhibits unintentional loosening of the spindle lock nut 114 on the spindle 14.

With reference to FIG. 2, the wheel hub body 16 has an inboard end portion 131 with an inboard end 133, an outboard end portion 135 with an outboard end 137, and a central opening 139 extending from the inboard end 133 to the outboard end 137. The wheel hub 12 system includes a circular brake element such as a drum or brake disc 133A mounted thereto. During assembly of the wheel hub assembly 12, the air seal cartridge 40 including the inboard lubricant seal 120 (see FIG. 4) thereof is advanced into the central opening 139 of the wheel hub body 16 in an outboard direction 129. In this manner, the air seal cartridge 40 provides a unitized assembly including the inboard lubricant seal 120 which may be readily mounted to the wheel hub body 16.

The air seal cartridge 40 has a diaphragm seal 200 having a clearance or disengaged configuration shown in FIG. 4 and a sealing or engaged configuration shown in FIG. 5. The diaphragm seal 200 includes one or more diaphragm members, such as diaphragms 202, 203 that permit radial expansion of the diaphragms 202, 203 upon inflation of the diaphragm seal 200. The diaphragms 202, 203 have ridges 204, 206 that are spaced from a rotatable sealing surface 210 of the seal sleeve 70 when the diaphragm seal 200 is in the disengaged configuration and engage the rotatable sealing surface 210 when the diaphragm seal is in the engaged configuration.

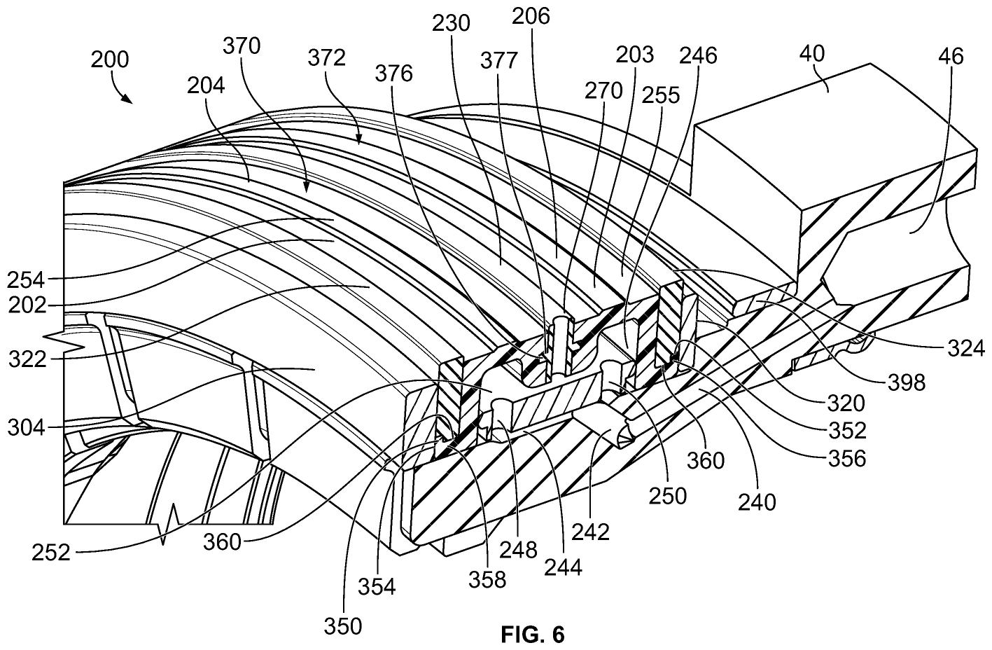

Regarding FIGS. 5 and 6, the non-rotatable pressurized air receiver 42 includes a mounting ring 304, diaphragm support rings 322, 324, a diffuser ring 230, and a diaphragm support base 246 that secure the diaphragms 202, 203 to the body 44 and constrain the expansion of the diaphragms 202, 203 to radial expansion and contraction as the diaphragm seal 200 shifts between the engaged and disengaged configurations. In other embodiments, the non-rotatable pressurized air receiver 42 may direct the movement of the one or more diaphragm members in different paths, such as axially or obliquely to the axis of rotation of the wheel hub body 16.

Regarding FIG. 6, the diaphragm seal 200 includes a diaphragm chamber 252 formed generally between the diaphragms 202, 203, the diffuser ring 230, and the diaphragm support base 246. The diaphragm support base 246 has openings 248, 250 that are radially aligned with the ridges 204, 206 of the diaphragms 202, 203. The body 44 has a passageway 240 with an outlet 242 pneumatically connecting the air inlet 46 and the diaphragm chamber 252. Upon pressurized air being introduced to the diaphragm chamber 252, the diaphragm chamber 252 has a higher internal air pressure than at radially outer surfaces 254, 255 (see FIGS. 5 and 6) of the diaphragm 202 which causes the diaphragms 202, 203 to bulge radially outward and engage the seal sleeve 70. More specifically, the pressure differential across the diaphragms 202, 203 bends portions 260, 262 of the diaphragms 202, 203 and shifts the ridges 204, 206 radially outward into sealing engagement with the rotatable sealing surface 210 of the seal sleeve 70 as seen by comparing FIGS. 4 and 5. The ridges 204, 206 engage the seal sleeve 70 and form two parallel lines of sealing engagement on either side of the diffuser ring 230. Regarding FIG. 6, the ridges 204, 206 of the diaphragms 202, 203 protrude from the radially outer surfaces 254, 255 and provide smaller contact surface area with the seal sleeve 70 which increases the sealing force between the diaphragms 202, 203 and the seal sleeve 70. Specifically, the ridges 204, 206 create a seal with a contact pressure greater than the air pressure in the diaphragm chamber 252.

With reference to FIG. 6, the diaphragm support rings 322, 324 have grooves 350, 352 that each receive a lip 354, 356 of a base flange portion 358, 360 of the diaphragms 202, 203. The lips 354, 356 are sandwiched in the grooves 350, 352 of the diaphragm support rings 322, 324 between flanges 360 of the diaphragm support rings 322, 324 and the mounting rings 304, 320. The diaphragm support rings 322, 324 secure the diaphragm base portions 358, 360 to the body 40 which forms a static seal between the diaphragms 202, 203 and the body 40. The diaphragm support rings 322, 324 may, in one embodiment, include split rings and a compliant member (e.g., plastic or hard rubber) to keep the ends of the split ring together. The compliant member permits controlled shifting of the ends of the split ring apart or together during operation and limiting binding during high load conditions.

In one embodiment, the mounting rings 304, 320 have an inner diameter sized to create an interference fit with the body 40 to fix the mounting rings 304, 320, diaphragm support rings 322, 324 and the diaphragm support base 248 in position along the body 40. Further, the diaphragm support base 248 maintains the axial spacing between the diaphragm base flange portions 358, 360, the diaphragm support rings 322, 324, and the mounting rings 304, 320.

The diaphragms 202, 203 are made of a resilient material such as a polymer, such as rubber or silicone, to permit the shifting of the ridges 204, 206 into sealing engagement with the seal sleeve 70. Various materials may be used for the diaphragms 202, 203, such as hydrogenated nitrile rubber (HNBR), fluoroelastomers, fluorocarbons, silicone, and/or ethylene acrylic elastomers. The mounting rings 304, 320 and diaphragm support rings 322, 324 are made of a rigid material, such as a metallic material such as steel or aluminum, that are sufficiently rigid to resist axial separation or bending of the diaphragm support rings 322, 324 upon pressurization of the diaphragm chamber 252. Instead, the diaphragm support rings 322, 324 direct contact portions 370, 372 of the diaphragm 202 radially outward. In the embodiment of FIG. 6, each diaphragm 202, 203 is connected to the diffuser ring 230 via a groove 376 that receives a flange 377 of the diffuser ring 230. The diffuser ring 230 may be made of a rigid material, such as steel or aluminum or plastic, and the diaphragms 202, 203 are molded onto the diffuser ring 230.

In one embodiment, the diaphragms 202, 203 are made of a flexible material and a spring biases the diaphragms 202, 203 toward the clearance position thereof. For example, the diaphragms 202, 203 may each include an elastomeric material to provide sealing engagement and a spring, such as a metallic or plastic spring, overmolded in the elastomeric material. Pressurized air is introduced in the diaphragm chamber 252 to overcome the spring bias force and shift the diaphragms 202, 203 into sealing engagement with the seal sleeve 70.

Regarding FIG. 5, the diaphragm seal 200 is shown in the sealing or engaged configuration wherein surface portions 220, 222 of the ridges 204, 206 of the diaphragms 202, 203 are firmly engaged with the rotatable sealing surface 210 of the seal sleeve 70 which forms an annulus 224 between the diaphragms 202, 203, the seal sleeve 70, and the diffuser ring 230. The diffuser ring 230 has a through opening 270 that opens to the annulus 224 and the diaphragm chamber 252. Pressurized air introduced to the air inlet 46 travels through passageway 240, through openings 248, 250, through opening 270, annulus 224, opening 72, opening 68, and into passageway 34 before traveling into the tire of the associated wheel. In this manner, the application of pressurized air at an air inlet 46 causes the diaphragms 202, 203 to seal against the seal sleeve 70 as well as causes pressurized air to flow from the air inlet 46 into the passageway 34 of the wheel hub body 16 to increase the tire pressure of a tire associated with the wheel hub body 16. The operability of the diaphragm seal 200 to shift to the engaged configuration and transfer pressurized air to the wheel hub passageway 34 in response to application of pressurized air at the air inlet 46 permits the diaphragm seal 200 to be controlled via operation of the valve 49 which may be positioned away from the road environment to improve the durability of the system.

In one embodiment, the electronic control unit 630 is configured to inflate the tire associated with the wheel hub assembly 12 only when the vehicle has a speed of less than a threshold, such as less than five miles per hour. The electronic control unit 630 thereby keeps the diaphragms 202, 203 from engaging the seal sleeve 70 at higher speeds, such as highway speeds, which could generate high frictional forces and operating temperatures that may shorten the lifespan of the diaphragms 202, 203. When the diaphragm seal 200 is in the disengaged configuration, the diaphragms 202, 203 are subject to less frictional and temperature-related wear during rotation of the wheel hub body 16 around the spindle 14 due to the reduced contact between the diaphragms 202, 203 and the seal sleeve 70. The diaphragms 202, 203 may be completely spaced from the seal sleeve 70 or in slight contact with the seal sleeve 70 when the diaphragm seal 200 is in the disengaged configuration depending on the particular embodiment of the air seal cartridge 40.

The wheel hub body 16 may have one passageway 34 and the air seal cartridge 40 may have one pressurized air outlet 67 to provide pressurized air to the passageway 34, such as if the wheel mounted to the wheel hub body 16 has a single tire. In another embodiment, the wheel hub body 16 includes two passageways 34, the air seal cartridge 40 has two pressurized air outlets 67, and the air distribution system 604 includes two pressurized air lines for providing pressurized air to the tires 606. The air distribution system 604 may further include valves associated with the air lines that are individually operable to permit pressurized air to flow into either tire, or both of the tires on the wheel hub rim, depending on the air pressure levels in the tires 606. Different pressure may be applied to the different tires by closing the valve associated with one tire and opening the valve associated with the tire to be further pressurized. The air distribution system 604 may include mechanical and/or digital controls. In one embodiment, the air distribution system 604 may include a bleed off valve to release air pressure in one or more tires 606 if the tire pressure is too high.

With reference to FIG. 4, the air seal cartridge 40 has an air leak path 310 that permits pressurized air to exit the air seal cartridge 40 if there is a failure of the diaphragm 202 rather than the pressurized air damaging the inboard lubricant seal 120, which preserves the operability of the inboard and outboard bearings 100, 102 despite the diaphragms 202, 203 being inoperable. More specifically, if either of the diaphragms 202, 203 are unable to engage the seal sleeve 70, pressurized air may exit the opening 270 (see FIG. 5) of the diffuser ring 230 and travel in direction 300 into a spacing 302 between the mounting ring 304 and the contaminant seal 160. The pressurized air in the spacing 302 urges the lip 166 of the contaminant seal 160 tightly against the flange 168 of the lubricant seal sleeve 122. The lip 166 directs pressurized air in direction 306 into a radial channel 307 of the spindle mount 134. The pressurized air travels axially through an air outlet channel 308 (see FIG. 3) and along a tapered radially outer surface 312 of the spindle 14 and through a contaminant seal 316. The air may then be discharged out from between the contaminant seal 316 and the spindle 14. The contaminant seal 316 permits egress of air along the air leak path 310 while inhibiting contaminants from entering into the interface between the body 44 and the spindle 14.

With continued reference to FIG. 4, the inboard lubricant seal 120 includes a lubricant seal sleeve 122 that may be made of a metallic material such as steel or aluminum and a spindle mount seal 124 that may be made of a resilient material such as rubber. The lubricant seal sleeve 122 has a ring 126 secured thereto that creates a tortuous path for lubricant. The spindle mount seal 124 has a groove 128 and a rib 131 that engage a corresponding rib 132 and recess 130 of a spindle mount 134 secured to the body 44. The spindle mount 134 has radially inner ridges 135 separated by the channels 308 that seat against the spindle 14. The rib 131 and ridge 132 overlap in an axial direction and inhibit relative axial movement of the body 44 and lubricant seal sleeve 122 which inhibits axial separation of the inboard lubricant seal 120 and the body 44. In one embodiment, the rib 131 may include a rigid material such as steel that engages the groove 128.

The inboard lubricant seal 120 further includes a seal case 140 having a seal body 142 that may be made of a metallic material, such as aluminum, and a sealing element 144 that may be made of a polymer material, such as rubber. The sealing element 144 has a radially outer portion that engages the radially inner surface 63 of the wheel hub body 16 and a radially inner portion including a lip seal 146. The lip seal 146 has a sealing portion 148 that engages a radially outer surface 149 of the lubricant seal sleeve 122. In one embodiment, the inboard lubricant seal 120 has a garter spring urging the sealing portion 146 into engagement with the lubricant seal sleeve 122.

With reference to FIG. 4, the air seal cartridge 40 has a predetermined lubricant leak path 150 such that the lubricant may exit the air seal cartridge 40 upon failure of the lubricant seal 120 and be visually detected by a technician on an outer surface of the wheel hub assembly 12, such as surface 152. More specifically, the rotatable pressurized air distributor 60 includes a contaminant seal 160 secured to a radially inner surface 162 of the seal sleeve 70. The contaminant seal 160 includes a first sealing member, such as a lip 164, that engages the sealing element 144 and a second sealing member, such as the lip 166, that engages the flange 168 of the lubricant seal sleeve 122. The lips 164, 166 direct the lubricant along lubricant leak path 150 while keeping the lubricant from fouling the diaphragm seal 200. For example, if the lip seal 146 has worn down and is spaced from the lubricant seal sleeve 122, lubricant may flow in directions 170, 172 between the sealing element 144 and the lubricant seal sleeve 122. The forces that act on the lubricant during rotation of the wheel hub 16 urge the lubricant in direction 174 underneath the lip 164 and into an opening 176 in the seal sleeve 70. The escaping lubricant travels into outlet channels 178 (see FIG. 3) and eventually discharges through an opening 180 between the sleeve mount 62 and the radially inner surface 63 of the wheel hub body 16. The lubricant may then travel radially outward along the surface 152 which provides a visual indication that the inboard lubricant seal 120 has failed. Alternatively or additionally, the wheel hub body 16 may have one or more holes formed therein that permit oil to travel outward therethrough and provides a visual indication of the failure of the inboard lubricant seal.

With reference to FIGS. 4 and 5, the air seal cartridge 40 includes a contaminant seal 389 to inhibit ingress of contaminants into the air seal cartridge 40. In one embodiment, the contaminant seal 389 includes a sealing member 392 integrally formed with the sleeve mount 62. The sealing member 392 has a lip 394 that engages an outer surface 396 of a sealing ring 398. The sealing ring 398 is mounted to the body 44 and is stationary relative to the spindle 14 whereas the lip 394 rotates with rotation of the wheel hub body 16 in engagement with the sealing ring 398. The lip 394 and sealing ring 398 are configured to urge contaminants axially inboard away from the interior of the air seal cartridge 40.

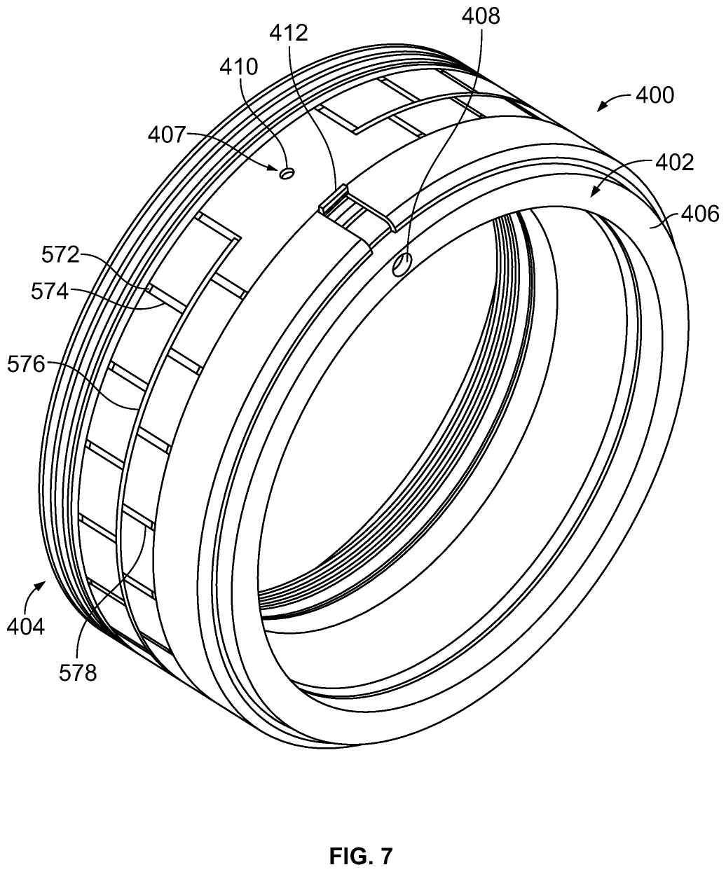

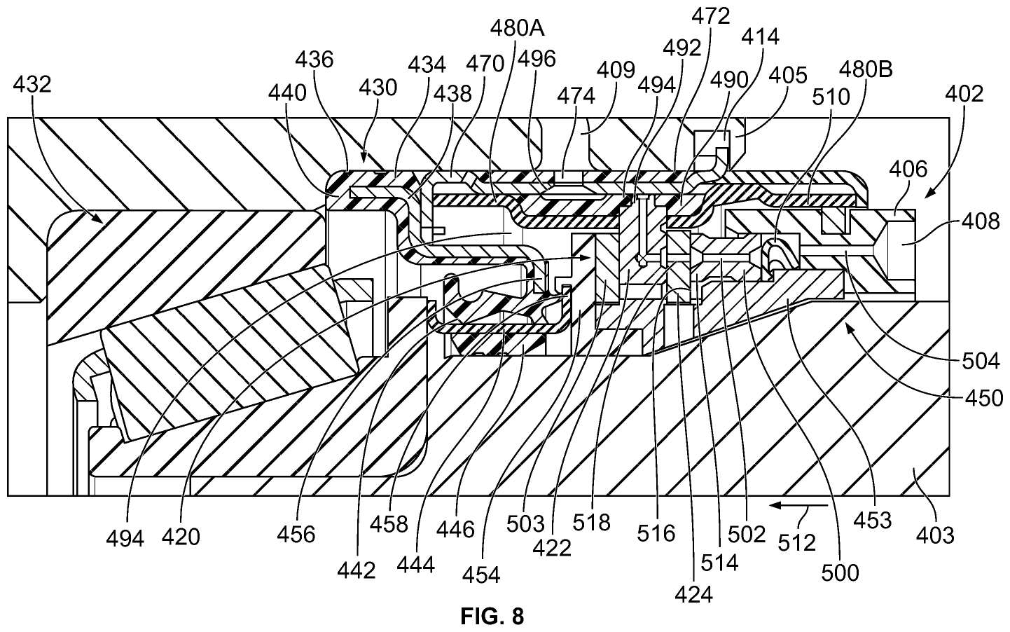

Regarding FIG. 7, an air seal cartridge 400 is provided that is similar in many respects to the air seal cartridge 40 discussed above such that differences will be highlighted. The air seal cartridge 400 includes a non-rotatable pressurized air receiver 402 to be mounted to a spindle 403 (see FIG. 8) and a rotatable pressurized air distributor 404 to be mounted to a wheel hub body 405. The non-rotatable pressurized air receiver 402 has a body 406 with an air inlet 408 to receive pressurized air. The rotatable pressurized air distributor 404 has a pressurized air outlet 407 with an outlet opening 410 to direct the pressurized air into a passageway 409 of the wheel hub body 405. The rotatable pressurized air distributor 404 is press-fit into the wheel hub body 405 which inhibits relative rotary movement of the rotatable pressurized air distributor 404 and the wheel hub body 405. The rotatable pressurized air distributor 404 also includes a key 412 that extends into a recess 414 (see FIG. 8) of the wheel hub body 405. The engagement of the key 412 of the rotatable pressurized air distributor 404 and the recess 414 of the wheel hub body 405 further inhibits relative rotary movement of the rotatable pressurized air distributor 404 and the wheel hub body 405.

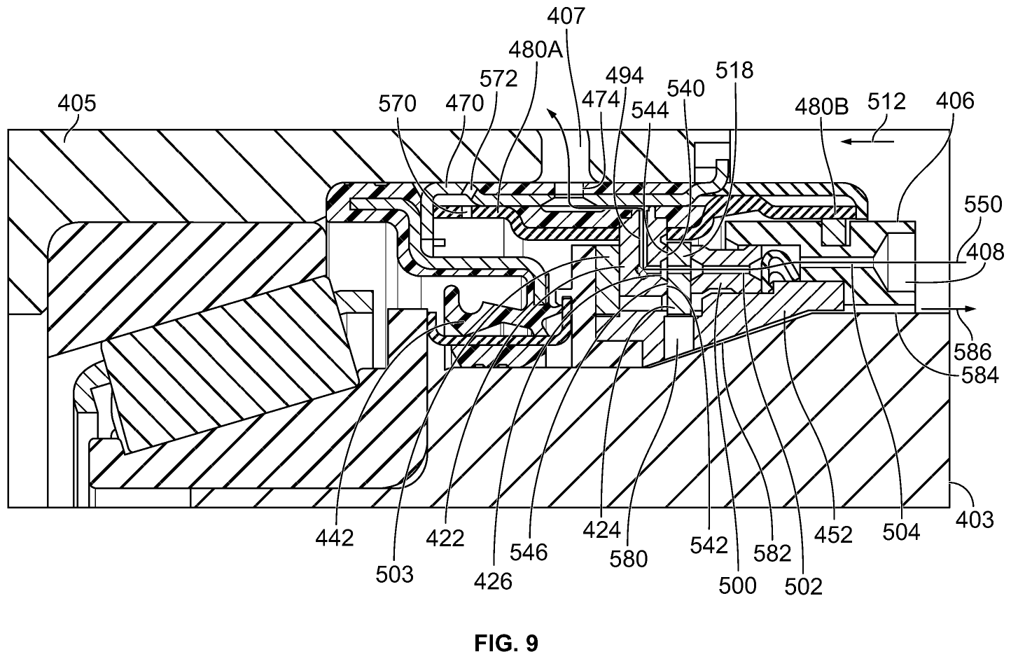

Regarding FIG. 8, the air seal cartridge 400 includes a face seal 420 having a disengaged configuration wherein there is nominal contact between a rotatable sealing member 422 of the rotatable pressurized air distributor 404 and a sealing member 424 of the non-rotatable pressurized air receiver 402. The face seal 420 is placed in the disengaged configuration during, for example, higher vehicle speeds, to limit frictional engagement, forces, and high temperatures created by way of contact between the rotatable sealing member 422 and the sealing member 424 caused by rotation of the wheel hub 405. The face seal 420 has an engaged configuration (see FIG. 9) wherein the sealing member 424 is tightly engaged with the rotatable sealing member 424 to form a transfer chamber 426 for conducting pressurized air into the passageway 409 of the wheel hub body 405.

With reference to FIG. 8, the air seal cartridge 400 includes a lubricant seal 430 for resisting egress of lubricant from an inboard bearing assembly 432. The lubricant seal 430 includes a seal case 434 mounted to a radially inner surface 436 of the wheel hub body 405 and rotatable therewith. The seal case 434 has a seal body 438 made of a rigid material, such as steel, aluminum, or a composite plastic, and a sealing member 440 that may be made of a polymer material, such as a rubber or a silicone. The lubricant seal 430 includes a lubricant seal sleeve 444 and a spindle mount sleeve 446. The sealing member 440 has a sealing member 442 that engages the lubricant seal sleeve 444 as the wheel hub body 405 rotates about the spindle 403. The spindle mount 446 may be made of polymeric material that inhibits lubricant flow between the lubricant seal sleeve 444 and the spindle 403.

The non-rotatable pressurized air receiver 402 includes an annular body such as receiver spindle mount 450. The receiver spindle mount 450 includes a receiver spindle mount assembly 449 including a body 406, a base 452, and a seal connector ring 454. The seal connector ring 454 has a lip 456 that overlaps a flange 458 of the lubricant seal sleeve 444 in the axial direction and inhibits axial separation of the receiver spindle mount 450 and the lubricant seal 430. The overlapping engagement of the lip 456 and the flange 458 increases the rigidity of the non-rotatable pressurized air receiver 402 on the spindle 403.

Regarding FIG. 8, the rotatable pressurized air distributor 404 includes a seal ring 470 and a sealing member 472 that engages the radially inner surface 436 of the wheel hub body 405 about the passageway 409. The seal ring 470 and the sealing member 472 have an outlet opening 474 formed therein that opens to the passageway 409. The rotatable pressurized air distributor 404 further includes support rings 480A, 480B having the rotatable sealing member 422 mounted thereto. In one embodiment, the rotatable sealing member 422 is fixed relative to the support rings 480A, 480B and the support rings 480A, 480B are fixed relative to the seal ring 470. In this manner, the rotation of the wheel hub body 405 causes rotation of the seal ring 470, the support rings 480A, 480B, and the rotatable sealing member 422. The rotatable pressurized air distributor 404 has a sealing member 490 that forms a seal around an outlet portion 492 of the rotatable sealing member 422. The sealing member 490 and support rings 480A, 480B define therebetween a channel 496 that directs pressurized air from rotatable sealing member outlet portion 492 into a chamber 496 before exiting through the opening 474 and traveling into the passageway 409.

The non-rotatable pressurized air receiver 402 includes a piston 500 having an opening 502 that may receive air via an opening 504 of the body 406. The non-rotatable pressurized air receiver 402 has a spring 510 that resiliently urges the piston 500 in direction 512 such that there is a slight contact between an outboard end portion 514 of the piston 500 and inboard face 516 of the non-rotatable sealing member 424 even when pressurized air is not applied to the air inlet 408. Further, the clearance between the non-rotatable sealing member 424 and the rotatable sealing member 424 when the face seal 420 is in the disengaged configuration limits contact at high rotational speeds of the wheel hub body 405 (such as at highway speeds) and the associated wear due to friction and heat. Thus, when the face seal 420 is in the disengaged configuration, there is nominal contact between the piston 500 and the non-rotatable sealing member 424 due to the spring 510 and the non-rotatable sealing member 424 is in clearance with the rotatable sealing member 422. The nominal contact between the piston 500 and the sealing member 424 ensures the piston 500 to seat against the sealing member 424 immediately upon application of pressurized air to the air inlet 408 and minimize leakage. The nominal contact between the piston 500 and the sealing member 424 also minimizes wear of the piston 500 and non-rotatable sealing member 422.

The sealing member 424 has an opening 518 that permits air flow to travel through and into the passageway 494. In this manner, when pressurized air is applied to the air inlet 408, the pressurized air creates a pressure differential across the piston 508 which increases the force acting on the piston 500 in direction 512 and tightly sandwiches the sealing member 424 between the piston 500 and the rotatable sealing member 422 as shown in FIG. 9.

In one embodiment, the non-rotatable pressurized air receiver 402 includes a thrust washer 503 on an opposite side of the rotatable sealing member 422 from the non-rotatable sealing member 424. At least one of the thrust washer 503, rotatable sealing member 422, and the non-rotatable sealing member 424 includes a wear resistant material. Example wear resistant materials include wear resistant plastics, such as polyamidimide (PAI) plastic and polybenzimidazole (PBI) plastic, and ceramic materials such as coatings.

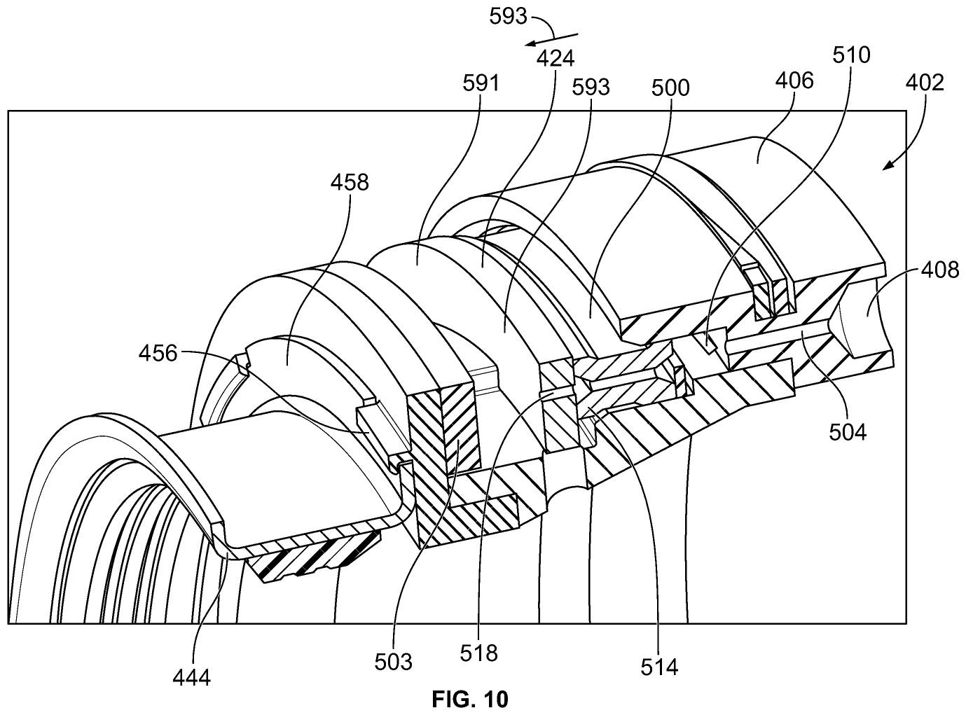

Regarding FIG. 10, the non-rotatable pressurized air receiver 402 is shown including the sealing member 424 and the thrust washer 503 having a channel 591 therebetween that receives the rotatable sealing member 422 (see FIG. 9). The sealing member 424 has a sealing surface 593 that engages the ridges 544, 546 of the rotatable sealing member 422 upon the piston 500 shifting in outboard direction 593 due to application of pressurized air at the air inlet 408. The thrust washer 503 may be in clearance with, or have nominal contact with, the rotatable sealing member 422 when the face seal 420 is in the disengaged configuration. When the face seal 420 is shifted to the engaged configuration by application of pressurized air at the air inlet 408, the thrust washer 503 provides a reaction force in a direction opposite the direction 512 to support the rotatable sealing member 422 against deflection.

The rotatable sealing member 422 has contact surface portions such as inboard surfaces 540, 542 of ridges 544, 546 that are tightly engaged by the sealing member 424 to define the transfer chamber 426. In this manner, the pressurized air applied to the air inlet 408 travels along a flow path 550 from the air inlet 408, through the opening 504 of the body 506, through the opening 502 of the piston 500, through the opening 518 of the sealing member 524, through the passageway 494 of the rotatable sealing member 422, through the opening 474 in the seal ring 470 and sealing member 472, and into the passageway 409 of the wheel hub body 405. In this manner, application of pressurized air to the air inlet 408 shifts the face seal 420 from the disengaged configuration to the sealing or engaged configuration.

Like the air seal cartridge 40, the air seal cartridge 400 permits lubricant to escape from the air seal cartridge 400 upon a failure of the lubricant seal 420. More specifically and with reference to FIG. 9, the support ring 480A has an opening 570 and the seal ring 470 has an opening 572 that permit lubricant to travel inboard from the lubricant seal 420 into lubricant outlet channels 574 (see FIG. 7) at a periphery of the air seal cartridge 400. The lubricant travels through lubricant outlet channels 574, into circumferential channel 576, and into secondary channels 578. The lubricant may then travel from the secondary channels 578 in an inboard direction between the seal ring 470 and the wheel hub body 405 and eventually onto an outer surface of the wheel hub body 405 for visual detection by a technician. The channels 576, 578 are circumferentially offset from one another to provide a tortuous path to resist debris ingress.

The air seal cartridge 400 also permits pressurized air to discharge from the air seal cartridge 400 upon failure of the face seal 420 rather than pressurizing and potentially damaging the lubricant seal 430. More specifically and with reference to FIG. 9, the base 452 has an outlet opening 580 that permits pressurized air to escape radially inward and travel along an air outlet passage 582 between the base 452 and spindle 403. The pressurized air exits the passage 582 through an inboard opening 584 between the body 406 and the spindle 403 in direction 586.

With reference to FIG. 11, the tire inflation system 600 includes a pressurized air rotary union 602 for communicating pressurized air from the vehicle pressurized air supply 48 to pressurized air distribution system 604, which may include one or more valves, tubes, and/or fittings to facilitate the transfer of pressurized air from the passageway of the rotatable wheel hub to the tire 606. In one embodiment, the pressurized air rotary interface 602 includes a non-rotatable pressurized air receiver 608 and a rotatable pressurized air distributor 610. The pressurized air rotary union 602 has an engaged configuration wherein the non-rotatable pressurized air receiver 608 and the rotatable pressurized air distributor 610 are operatively coupled to permit pressurized air flow therebetween and a disengaged configuration wherein the pressurized air rotary union 602 is unable to communicate pressurized air between the non-rotatable pressurized air receiver 608 and the rotatable pressurized air distributor 610. Examples of the non-rotatable pressurized air receiver 608 are the non-rotatable pressurized air receivers 42, 402 and examples of the rotatable pressurized air distributors are the rotatable pressurized air distributors 60, 404 discussed above.

The system 600 includes a tire pressure sensor 620 configured to detect the internal air pressure of the tire 606, one or more sensors 622, and one or more wheel end devices 624 operatively connected to an electronic control unit 630. The sensors 622 may include, for example, an ambient temperature sensor, a tire temperature sensor, a wheel hub temperature sensor, a stud tension sensor, an accelerometer, and a gyroscope, a tire life sensor, as some examples. The wheel end devices 624 may include, for example, a valve such as a valve to release pressurized air from the tire 606, an antenna, and/or an antilock brake sensor, as some examples. The electronic control unit 630 has communication circuitry 632 that receives one or more parameters of the vehicle and the surrounding environment via the sensors 622 and/or a network 634. The network 634 may include a wired network, such as a vehicle specific network e.g., a CAN bus. Additionally or alternatively, the network 634 may include a wireless network such as a Wi-Fi network, a local area wireless network, and/or a mesh network, as some examples. The network 634 may include the internet and/or a wide area wireless network such as a cellular network as some examples.

The electronic control unit 630 includes a non-transitory computer readable medium, such as memory 635, for storing information regarding control logic for the system 600, such as parameters, thresholds, limits, historical data, machine learning algorithms such as neural networks, and other information. The memory 635 may include, for example, RAM, ROM, DRAM, and/or a hard disk drive. The electronic control unit 630 includes a processor 636 such as a microprocessor, application specific integrated circuit, and/or a system on a chip as some examples. The processor 636 utilizes the information stored in the memory 635 for controlling the system 600 as discussed below.

The processor 636 may operate the communication circuitry 632 to send command signals to the pumps 52 and/or receive information regarding the pump 52 such as pump status, pump health, pump speed, and/or other parameters. The electronic control unit 630 may be dedicated for controlling the tire inflation system 600 or may be involved with the operations of other systems of the vehicle. The electronic control unit 630 may communicate with the vehicle control unit 638 via the network 634. For example, the electronic control unit 630 may communicate tire pressure data to the vehicle control unit 638 for providing to a user via a user interface 640, such as a touchscreen, heads-up display, and/or stereo system, of the vehicle. The user interface 640 may provide information regarding the system 600 to a user such as a tire condition warning, leak detection, and system status.

In one embodiment, the electronic control unit 630 may also receive a user input from the user interface 640 via the network 634 to, for example, increase the pressure of the tire 606. The electronic control unit 630 checks whether the vehicle speed is less than an upper limit, such as three miles per hour. If the vehicle speed is less than the upper limit, the electronic control unit 630 sends a command to the vehicle pressurized air supply 48 via the network 634 that opens a valve of the vehicle pressurized air supply 48 to provide pressurized air to the non-rotatable seal portion 608 and inflate the tire 606. The electronic control unit 630 may also provide information to a remote computer 642, such as a cloud-based computing system, a desktop PC of a fleet manager, and/or a smartphone, regarding a parameter of the tire inflation system 600, a condition of the tire inflation system 600, and historical information regarding the tire inflation system 600. As another example, the electronic control unit 630 may receive updates or other information from the remote computer 642, such as updated machine learning algorithms based on historical data of a fleet of vehicles associated with the subject vehicle to improve the operation of the electronic control unit 630 as operating information is gathered from the fleet.

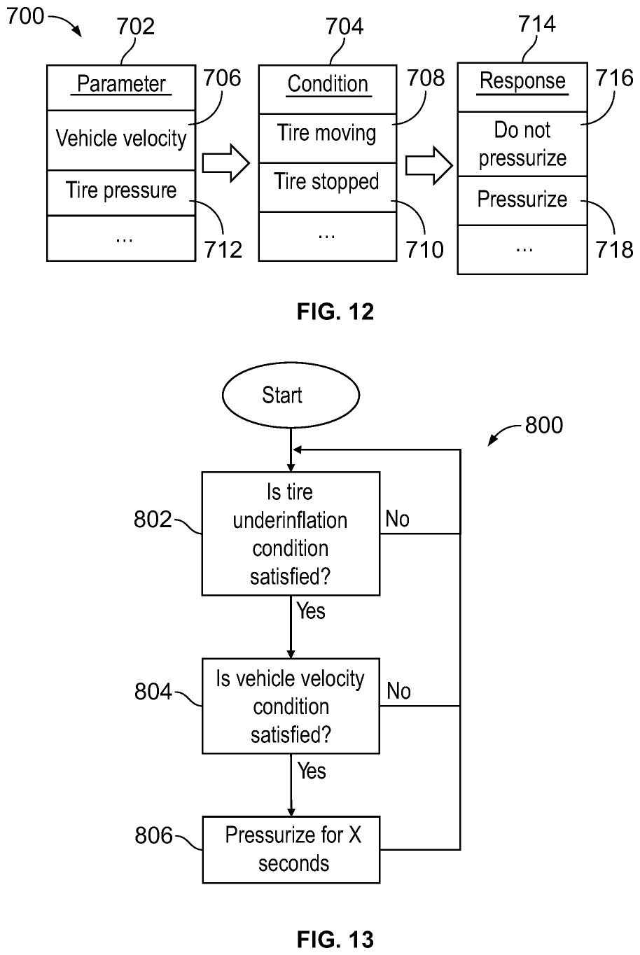

With reference to FIG. 12, a flow diagram of a method 700 is provided for tire pressure management. The method 700 may be implemented by the processor 636 of the electronic control unit 630 based on parameters 702 detected by the sensors 622. The processor 636 determines a condition 704 from the parameters 702 and a response 714. For example, if vehicle velocity 706 is greater than zero miles per hour, the processor 636 may determine that the tire 606 is moving 708. Conversely, if the vehicle velocity 706 is zero miles per hour, the processor 636 may determine that the tire 606 is stopped 710.

The condition 704 may encompass multiple conditions 704 of the vehicle and the determination of the response 714 may be based on multiple parameters 702. For example, if the condition 704 determined by the processor 636 is that the tire 606 is moving 708 and the tire pressure 712 is below a threshold, the processor 636 may determine a response 716 to not apply pressurized air to the tire 606. Conversely, if the condition 704 indicates that the tire is stopped 710 and the tire pressure 712 is below the threshold, the processor 636 may determine a response 716 to pressurize 718 the tire by opening the valve 49 of the vehicle pressurized air supply 48 to release pressurized air from the reservoir 50 to the non-rotatable seal portion 608. In one embodiment, the processor 636 monitors the tire pressure 712 via the tire pressure sensor 620 and closes the valve 49 upon the tire pressure 712 exceeding the threshold or the vehicle beginning to move and having a non-zero velocity. The following table provides examples of parameters 702, conditions 704, and responses 714 that may be utilized with the method 700. Each row of the table indicates one or more parameters, a condition associated with the one or more parameters, and a corresponding response by the system 600 to the condition.

TABLE 1
Parameters, conditions, and responses of a method
of controlling a tire inflation system

| Parameter | Condition | Response |
|---|---|---|
| Vehicle Velocity | Tire Moving | No Pressure |
| Vehicle Velocity | Stopped | Pressurize |
| Vehicle Velocity | Vehicle velocity < threshold | Pressurize |
| Vehicle Transmission gear | Vehicle state not in parking | No Pressure |
| selection | gear | |
| Vehicle Velocity + Tire | Vehicle velocity within speed | Pressurize for Y seconds |
| Pressure | band (e.g. 5-15 MPH), Tire | |
| | measured pressure - Tire | |
| | setpoint pressure, Seal thermal | |
| | PV coefficient (PV may be | |
| | used for a low velocity fill, and | |
| | is equal to pressure * velocity) | |
| Tire Pressure + Velocity | Pressure Low and Stopped | Pressurize at X Outlet |
| | | Pressure |
| Tire Pressure + Velocity + | Pressure Low, Stopped, and | Pressurize at X Outlet |
| Tire Temperature + | Temperature Stable | Pressure |
| (optional) Ambient | | |
| Temperature | | |
| Tire Pressure + Tire | Leakage detected from | Tire Condition Alert |
| Temperature | deviation of adjusted pressure | No Pressure |
| | formula = function(P/T), e.g. | |
| | P/T = constant | |
| Vehicle Velocity + | Stopped and above Min | Pressurize |
| Temperature of Union 602 | temperature but below Max | |
| | temperature | |
| Vehicle Velocity + | Stopped but inferred heat | No Pressure |
| Acceleration/Brake Time | generated by brakes based on | |
| | Acceleration Rate and Time | |
| | greater than set point | |
| Ambient Temperature + | Infer velocity from | No Pressure |
| Temperature of Union 602 | temperature differential below | |
| | set point | |
| Vehicle Velocity + Axle | Stopped | Pressure at X outlet |
| Load | | pressure, minimum X |
| | | outlet pressure calculated |
| | | at least in by Axle Load |
| Vehicle Velocity + Axle | Stopped, Tire pressure lower | Pressure at X outlet |
| Load + Tire Pressure | than desired set point | pressure calculated at least |
| | | in part by Axle Load |
| Vehicle Velocity + Axle | Stopped, Tire pressure higher | Reduce tire pressure. |
| Load + Tire Pressure + | than desired set point and | With outboard pneumatic |
| Tire Temperature + | Temperature Stable | logic valves, reducing tire |
| Outboard Deflation | | pressure may include |
| Hardware | | reducing tire pressure |
| | | until tire pressure reaches |
| | | X outlet pressure |
| | | calculated at least in part |
| | | by Axle Load. If other |
| | | hardware is used, such as |
| | | delayed closed check |
| | | valves, the algorithm may |
| | | require pressure pulses at |
| | | X outlet pressure |
| Vehicle Velocity + Tire | Stopped + Supply pressure > | Pressurize, starting at |
| Pressure + Source | greater than desired pressure | Pressure > set point to |
| Pressure | | accelerate fill and reduce |
| | | to ensure dual matching. |
| | | May accelerate |
| | | pressurizing if stop |
| | | duration is short. The on- |
| | | wheel air distribution |
| | | system may reduce |
| | | airflow to a first tire while |
| | | a second tire is |
| | | pressurized due to the first |
| | | tire reaching the pressure |
| | | set point before the second |
| | | tire. |
| Vehicle Velocity + Tire | Vehicle velocity < threshold | Pressurize, starting at |
| Pressure + Source | velocity + Supply pressure > | Pressure > set point to |
| Pressure | greater than desired pressure | accelerate fill and reduce |
| | | to ensure dual matching |

Various parameters may be used with the method 800. For example, the parameters may include wheel angular velocity, information from the antilock brake system, tire air temperature, tire material temperature, tire air flow rate, air supply flow rate (e.g., from the valve 49), air supply volume (e.g., compressor and/or tank size), time, air quality, humidity, oil content of the air, tire information such as material, type, and/or manufacturer, and vehicle configuration such as whether the tire 606 is a drive wheel, steer wheel, single tire wheel, or dual tire wheel. Further parameters 702 that may be utilized include a control state of whether the other tires in the vehicle are being inflated, a user setting such as tire pressure setpoint, and safety parameters such as operating range limits. The operating range limits may include limits for air pressure, vehicle speed, wheel angular velocity, and temperature as some examples. The parameters may be directly measured or may be inferred from other data. For example, the vehicle velocity may be inferred from an accelerometer measurement.

With reference to FIG. 13, a method 800 of controlling the pressure of a tire is provided. The electronic control unit 630 may operate the method 800 independently or in concert with the vehicle control 638 or other vehicle control units of the vehicle. The electronic control unit 630 may perform the method 800 autonomously while the vehicle is operating.

The method 800 includes the processor 636 determining 802 whether a tire underinflation condition is satisfied. Operation 802 may include, for example, determining whether the tire pressure detected by the tire pressure sensors 620 is below a threshold pressure, a percentage of a target pressure, within a range of acceptable pressures, or other approaches. If the tire underinflation condition is not satisfied at operation 802, the electronic control unit 630 again checks whether the tire underinflation condition is satisfied at operation 802.

If the tire underinflation condition is satisfied at operation 802, the electronic control unit 630 determines 804 whether the vehicle velocity condition is satisfied. The vehicle velocity condition may be satisfied when the vehicle speed is zero. As another approach, the vehicle velocity condition may be satisfied if the vehicle velocity is less than a non-zero threshold, such as five miles per hour. The processor 636 may determine vehicle speed based on information from the vehicle control unit 638. As another example, the sensor 622 may include an accelerometer of the wheel hub that can provide information regarding the rotational speed of the wheel hub.

If the vehicle velocity condition is not satisfied at operation 804, the electronic control unit 630 again performs operation 802. The electronic control unit 630 may wait a predetermined time period until performing operation 802 or may standby for a vehicle speed indication from the vehicle control unit 638 indicating the vehicle has stopped.

If the vehicle velocity condition is satisfied at operation 804, the electronic control unit 630 pressurizes 806 the tire 606 for a time period. The pressurizing 806 may include the electronic control unit 630 opening the valve 49 to apply pressurized air to the non-rotatable pressurized air receiver 608 for the time period. The time period may be fixed such as five seconds. The electronic control unit 630 closes the valve 49 at the end of the five seconds and repeats operations 802, 804, 806 until the pressure of the tire 606 is above the threshold pressure.

In one embodiment, the system 600 permits dynamic inflation of the tire 606 when the vehicle is in motion. The time period may be short, such as three seconds, to limit the duration of the engagement between the sealing portions of the pressurized air rotary union 602. The system 600 may implement a delay period, such as two minutes, to permit the sealing portions to cool off before again pressurizing 806 the tire 606.

In another embodiment, the time period is variable. For example, the time period may be the time required to raise the tire pressure of the tire 606 above a threshold tire pressure. The time period may be truncated by movement of the vehicle and the electronic control unit 630 returns to operation 802. The processor 636 may operate a timer during the pressurizing 806 that times out if the pressurization process takes longer than a predetermined value, such as one minute. The expiration of the timer without the tire pressure reaching the threshold value may indicate the tire 606 has a leak, and the electronic control unit 630 communicates with the vehicle control unit 638 to provide an alert to the user of the vehicle via the user interface 640.

The tire inflation system 600 may control inflation of multiple tires of the vehicle. For example, the tire inflation system 600 may have a first electronic control unit 630 that controls inflation of tires of drive wheels of a tractor, a second electronic control unit 630 that controls inflation of tires of steer wheels of the tractor, and a third electronic control unit 630 that controls inflation of tires of a trailer connected to the tractor.

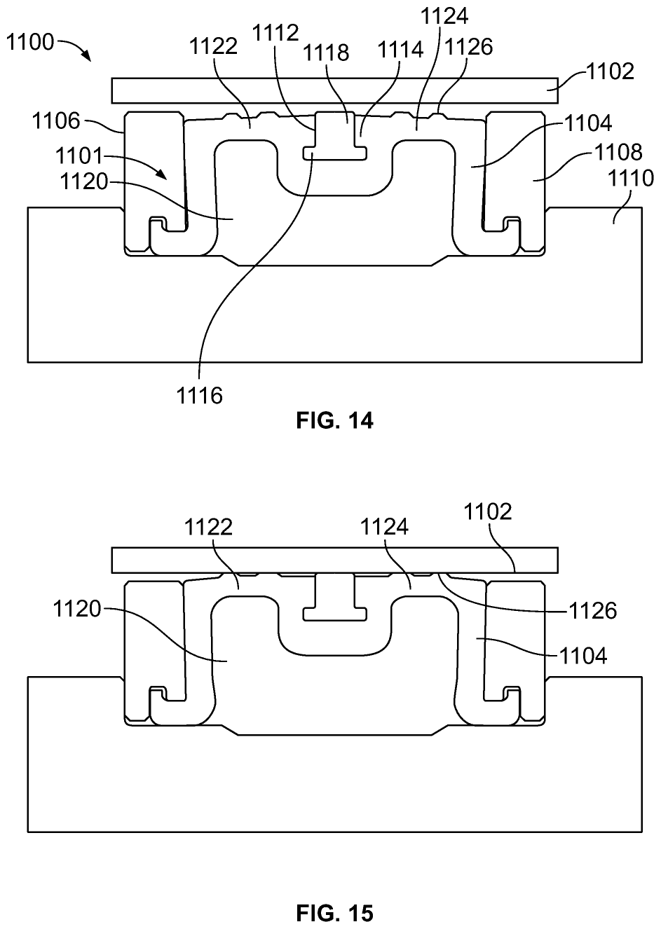

With reference to FIGS. 14 and 15, a portion of an air seal cartridge 1100 is provided that is similar to the air seal cartridge 40 discussed above. The air seal cartridge 1100 has a diaphragm seal 1101 with a disengaged configuration (FIG. 14) and an engaged configuration (FIG. 15). The air seal cartridge 1100 includes a seal sleeve 1102, a diaphragm 1104, diaphragm support rings 1106, 1108, and a body 1110 for mounting to a spindle. The diaphragm 1104 has a groove 1112 with lips 1114 engaging a flange 1116 of a diffuser ring 1118. The air seal cartridge 1100 has a diaphragm chamber 1120 to receive pressurized air. The application of pressurized air into the diaphragm chamber 1120 causes portions 1122, 1124 of the diaphragm 1104 to bulge outward and engage ridges 1126 of the diaphragm 1104 with the seal sleeve 1102. The application of pressurized air into the diaphragm chamber 1120 shifts the diaphragm seal 1101 from the disengaged configuration of FIG. 14 to the engaged configuration of FIG. 15. Although not shown in FIGS. 14 and 15, the diaphragm 1104 and the diffuser ring 1118 have aligned openings that permit pressurized air to flow from the diaphragm chamber 1120 into a passageway of a wheel hub to which the seal sleeve 1102 is mounted.

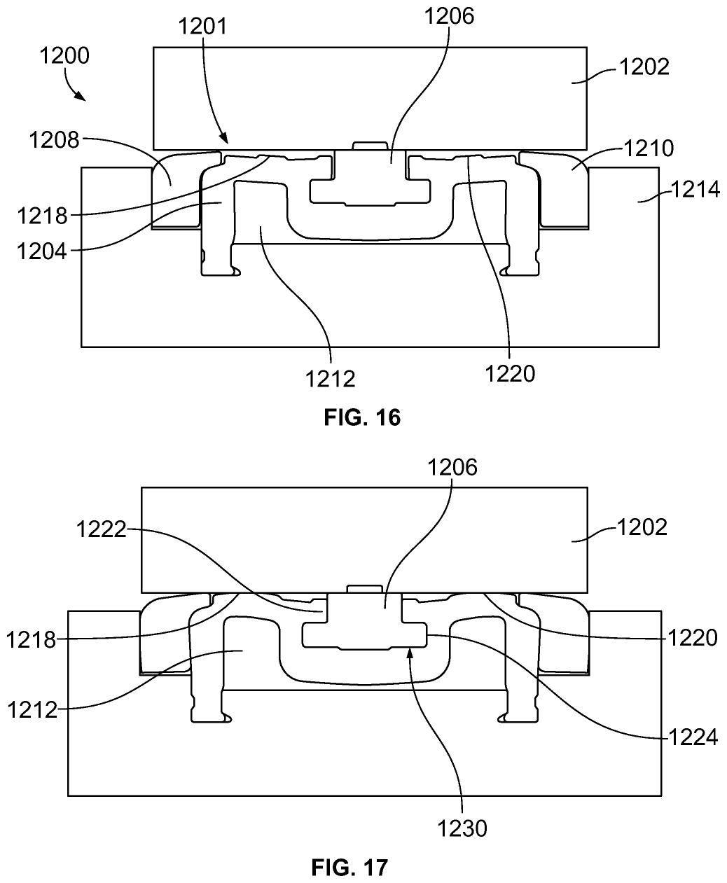

With reference to FIGS. 16 and 17, a portion of an air seal cartridge 1200 is provided that is similar to the air seal cartridges 40, 1100 discussed above. The air seal cartridge 1200 has a diaphragm seal 1201 with a disengaged configuration (FIG. 16) and an engaged configuration (FIG. 17). The air seal cartridge 1200 includes a seal sleeve 1202, a diaphragm 1204, a diffuser ring 1206, diaphragm support rings 1208, 1210, a diaphragm chamber 1212, and a body 1214 for mounting to a spindle. Introducing pressurized air into the diaphragm chamber 1212 shifts ridges 1218, 1220 into engagement with the seal sleeve 1214. The diaphragm 1204 has a neckdown portion 1222 and an enlarged portion 1224 to retain a protrusion of the diffuser ring 1206 such as flange 1230.

One difference between the air seal cartridges 1100, 1200 is that the diffuser ring 1118 of the air seal cartridge 1100 is spaced from the seal sleeve 1102 when the air seal cartridge 1100 is in the disengaged configuration (see FIG. 14) whereas the diffuser ring 1206 of the air seal cartridge 1200 is in contact with the seal sleeve 1202 when the air seal cartridge 1200 is in the disengaged configuration (see FIG. 16). The diffuser ring 1206 contacting the seal sleeve 1202 may operate as a secondary diffuser and as rigid sealing member.

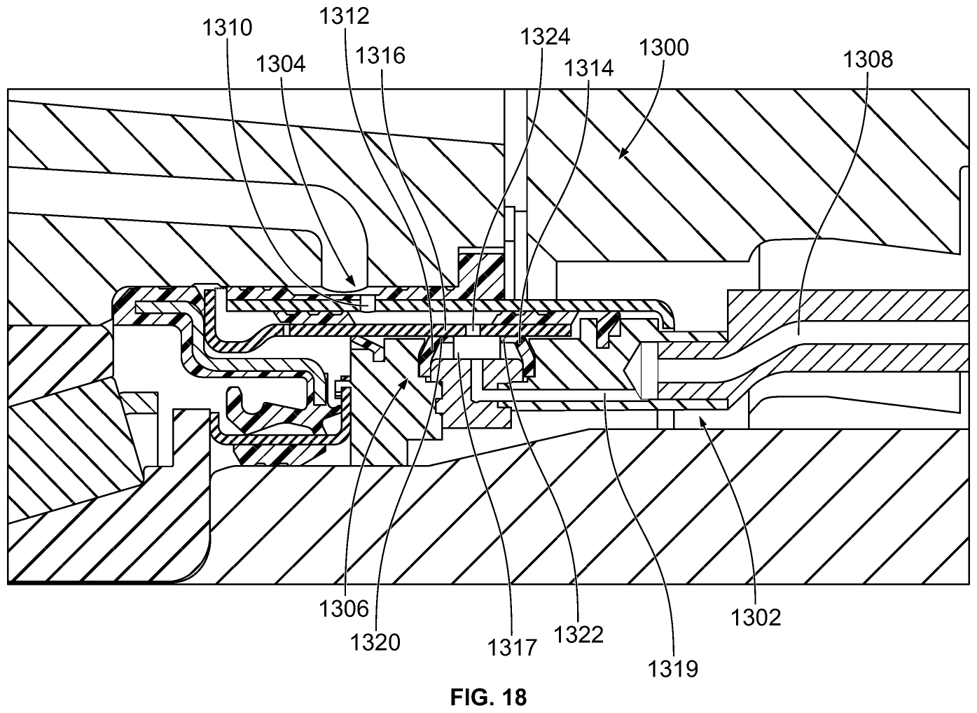

Regarding FIG. 18, an air seal cartridge 1300 is provided that is similar in many respects to the air seal cartridges discussed above. The air seal cartridge 1300 includes a non-rotatable pressurized air receiver 1302 and a rotatable pressurized air distributor 1304. The air seal cartridge 1300 has a lip seal 1306 shiftable from a disengaged configuration to an engaged configuration to enable pressurized air to flow from an air inlet 1308 of the non-rotatable pressurized air receiver 1302 to an air outlet 1310 of the rotatable pressurized air distributor 1304. The lip seal 1306 includes sealing members 1312, 1314 of the non-rotatable pressurized air receiver 1302 that contact a seal ring 1316 of the rotatable pressurized air distributor 1304. The sealing members 1312, 1314 and seal ring 1316 form a compartment 1317 that receives pressurized air from the air inlet 1308 via a passageway 1319 of the non-rotatable pressurized air receiver 1302.

The sealing members 1312, 1314 have lip portions 1320, 1322 that have a slight contact with the seal ring 1316 when the lip seal 1306 is in the disengaged configuration. Thus, the lip portions 1320, 1322 contact the seal ring 1316 even at high vehicle speeds. The sealing members 1312, 1314 may be made of, for example, a polymer such as rubber or silicone. When compressed air is provided to the air inlet 1308, the increase in pressure in the compartment 1317 tightly urges the lip portions 1320, 1322 against the seal ring 1316 and reconfigures the lip seal 1306 to the engaged configuration. Pressurized air may then flow from the compartment 1317, through an opening 1324 of the seal ring 1316, and to the air outlet 1310 of the rotatable pressurized air distributor 1304.

With reference to FIG. 19, an air seal cartridge 1400 is provided that is similar in many respects to the air seal cartridge 1300. The air seal cartridge 1400 includes a non-rotatable pressurized air receiver 1402, a rotatable pressurized air distributor 1404, and a lip seal 1406. The lip seal 1406 includes sealing members 1408, 1410 of the rotatable pressurized air distributor 1404. The rotatable air distributor 1404 has support rings 1420, 1422, 1424 securing the sealing members 1408, 1410 to an outer ring 1425 of the rotatable pressurized air distributor 1404.

The sealing members 1408, 1410 have lip portions 1412, 1414 that are in slight contact with a sealing ring 1416 of the non-rotatable pressurized air receiver 1402 when the lip seal 1406 is in a disengaged configuration. The sealing members 1408, 1410 and sealing ring 1416 form a compartment 1426 in communication with an air inlet 1428 of the non-rotatable pressurized air receiver 1402 via an opening 1430 of the sealing ring 1416 and a passageway 1431. Upon pressurized air being applied to the air inlet 1428, the increase in air pressure within the compartment 1426 urges the lip portions 1412, 1414 of the sealing members 1408, 1410 more tightly against the sealing ring 1416 and reconfigures the lip seal 1406 to the engaged configuration. Pressurized air may thereby flow from the compartment 1426, through an opening 1440 in the support ring 1422, through an opening 1442 in the outer ring 1425, and to an air outlet 1444 of the air seal cartridge 1400.

Regarding FIG. 20, an air seal cartridge 1500 is provided that is similar in many respects to the air seal cartridges discussed above. The air seal cartridge 1500 includes a non-rotatable pressurized air receiver 1502, a rotatable pressurized air distributor 1504, and a lip seal 1506. The lip seal 1506 includes sealing members 1508, 1510 of the non-rotatable pressurized air receiver 1502. The sealing members 1508, 1510 may be made of a hard plastic material.

The sealing members 1508, 1510 have lip portions 1512, 1514 with a slight contact with an annular body 1516 of the pressurized air distributor 1504 when the lip seal 1506 is in a disengaged configuration. The sealing members 1508, 1510 and annular body 1516 form a compartment 1520 that receives pressurized air from an air inlet 1522 of the non-rotatable pressurized air receiver 1502 via a passageway 1524 and a manifold 1526. The application of pressurized air to the air inlet 1522 increases the air pressure in the compartment 1520 and urges the lip portions 1512, 1514 against the annular body 1516 to reconfigure the lip seal 1506 to the engaged configuration. The pressurized air may exit the air seal cartridge 1500 at an outlet opening 1530 of the annular body 1516.

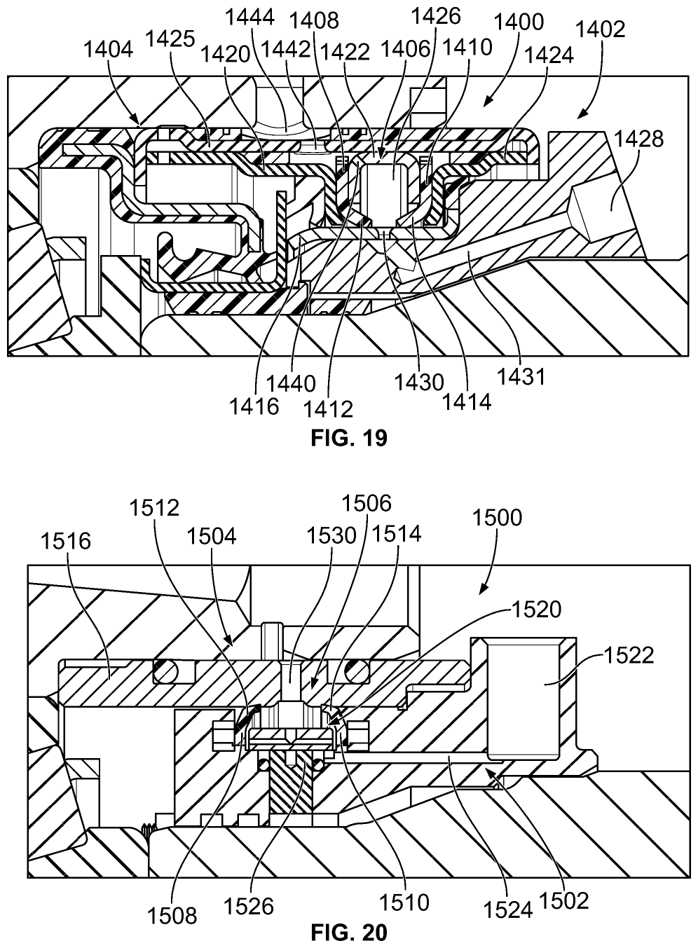

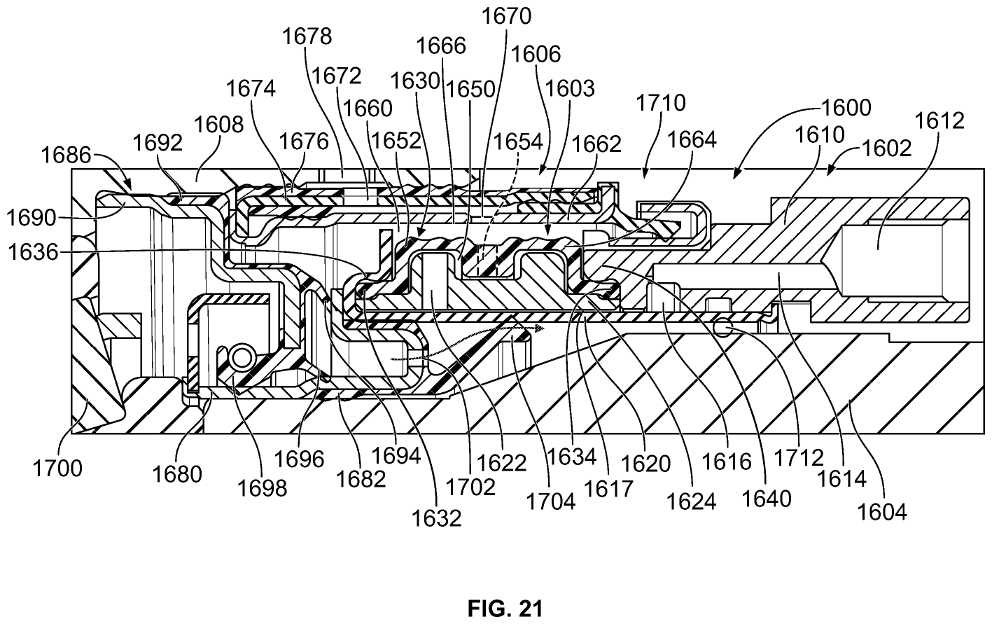

Regarding FIG. 21, an air seal cartridge 1600 is provided that is similar in many respects to the air seal cartridges discussed above. The air seal cartridge 1600 includes a non-rotatable pressurized air receiver 1602 for being mounted to a spindle 1604 of a vehicle and a rotatable pressurized air distributor 1606 that is mounted to a wheel hub 1608 that rotates about the spindle 1604. The non-rotatable pressurized air receiver 1602 has a body 1610 with an air inlet 1612 and an air passageway 1614 that leads to an opening 1616. The non-rotatable pressurized air receiver 1602 includes a diaphragm 1630 having mounting portions such as base flange portions 1632, 1634 clamped between a diaphragm support base 1624 and either a channel portion 1636 of a seal sleeve 1620 or a collar 1640 of the body 1610.

Pressurized air provided to the air inlet 1612 travels through the air passageway 1614, through the opening 1616, through a gap 1617 between the body 1610 and the seal sleeve 1620, and into an opening 1622 of the diaphragm support base 1624. The pressurized air may flow from the opening 1622 into a chamber 1650 between the diaphragm support base 1624 and the diaphragm 1630. The diaphragm 1630 includes a resilient diaphragm member 1652 and an air outlet such as an opening 1654. The opening 1654 permits pressurized air to travel into a gap 1660 between the diaphragm 1630 and a rotatable sealing ring such as seal sleeve 1662. The pressure differential between the pressurized air in the chamber 1650 and the ambient air in the gap 1660 causes a contact portion 1664 of the diaphragm 1630 to balloon or protrude radially outward and engage a sealing surface 1666 of the seal sleeve 1662. The engagement between the contact portion 1664 and the sealing surface 1666 forms an airtight seal that permits pressurized air in the chamber 1650 to flow through the opening 1654, through an opening 1670 in the seal sleeve 1662, through outlet openings 1672 in an outer ring 1674 and sleeve mount 1676, and into an inlet port 1678 of a passageway of the wheel hub 1608.

The non-rotatable pressurized air receiver 1602 includes a sleeve body 1680 with a sealing member 1682 that engages an outer diameter of the spindle 1604. The sealing member 1682 has a dirt exclusion lip seal 1704 to keep dirt or other debris from traveling in an outboard direction into the bearings 1700. The non-rotatable pressurized air receiver 1602 has an inboard o-ring 1712 to keep dirt and other debris away from the lip seal 1704. The o-ring 1712 also seals air pressure in the air seal cartridge 1600.

The rotatable pressurized air distributor 1606 includes a seal case 1686 mounted to the wheel hub 1608 with a seal body 1690 and a sealing element 1692. The sealing element 1692 has a lubricant-to-air protection lip seal 1694, air-to-lubricant protection lip seal 1696, and a main lip seal 1698. The lip seals 1694, 1696, 1698 engage surfaces of the sleeve body 1680 to form seals that inhibit an inboard flow of lubricant away from bearings 1700.

The sleeve body 1680 and the sealing element 1682 have a through opening 1702. In the event of failure of the diaphragm seal 1603, pressurized air can escape by deflecting the lubricant-to-air protection lip seal 1694, traveling through the through opening 1702, and past the lip seal 1704. In addition, lip seal 1696 will be urged tightly against the sleeve body 1680 by the escaping pressurized air and inhibit the air from damaging the lip seal 1698.

If lubricant (e.g., oil) were to leak from the lip seal 1698 and come out through the lip seal 1696, the lip seal 1694 will direct the lubricant to drain through the through opening 1702 and past the lip seal 1704.

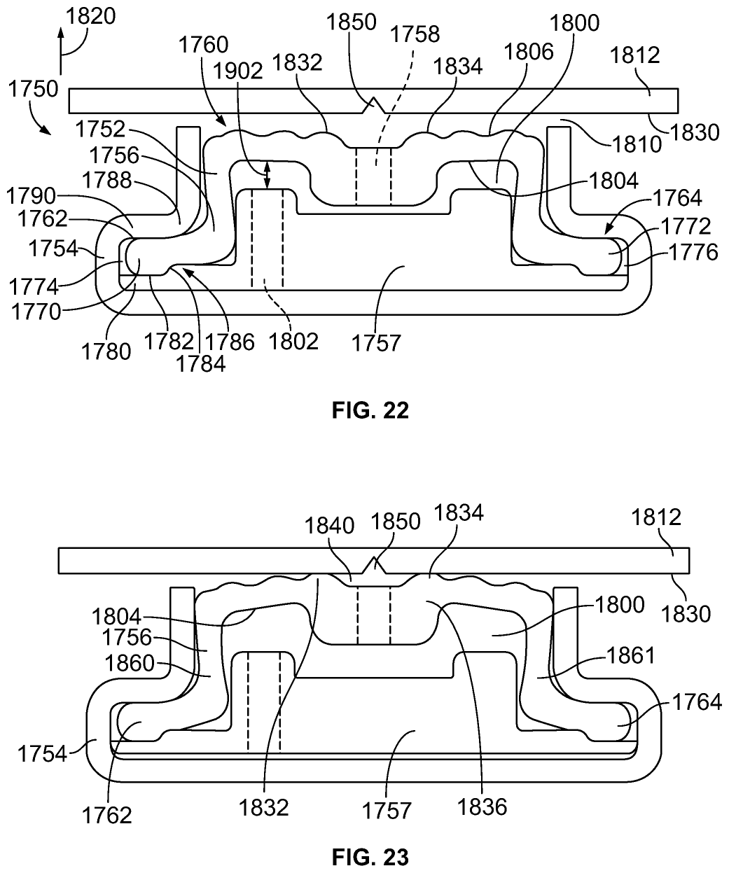

Regarding FIG. 22, a diaphragm seal 1750 is provided that is similar in many respects to the diaphragm seal 1603 of FIG. 21. The diaphragm 1603 operates in a manner similar to the manner discussed below with respect to diaphragm seal 1750. The diaphragm seal 1750 is operable through a wide range of operating temperatures such as at 70° F. in FIG. 22, 300° F. in FIG. 27, or −40° F. in FIG. 32.

The diaphragm seal 1750 includes a diaphragm 1752, a seal sleeve 1754, and a diaphragm support base 1757. The diaphragm 1752 includes a resilient diaphragm member 1756 having an air outlet 1758 formed in a contact portion 1760 of the diaphragm member 1756. The diaphragm member 1756 further includes mounting portions such as base flange portions 1762, 1764 with bulbous rings 1770, 1772 received in channels 1774, 1776 of the seal sleeve 1754.

With reference to the base flange portion 1762, the diaphragm support base 1757 has a lip portion 1780 with a flat surface 1782 and an inclined surface 1784 engaged with a radially inner surface portion of the base flange portion 1762. The inclined surface 1784 cooperates with a bend 1788 of the seal sleeve 1754 to form a neck down region 1786 that inhibits the pull-through of the bulbous ring 1770 from between the seal sleeve 1754 and the diaphragm support base 1757. Further, the bulbous ring 1770 may be compressed between the lip portion 1780, the incline surface 1784, and a wall portion 1790 of the seal sleeve 1754. In this manner, the base flange portion 1762 is securely fixed to the seal sleeve 1754 and the diaphragm support base 1757. The base flange portion 1764 is likewise fixed between the seal sleeve 1754 and the diaphragm support base 1757. Further, the base flange portions 1762, 1764 form an airtight seal with the diaphragm support base 1757 so that pressurized air introduced into a chamber 1800 of the diaphragm seal 1750 via opening 1802 of the diaphragm support base 1757 must exit the chamber 1800 via the air outlet 1758.

Regarding FIG. 22, the diaphragm member 1756 has an internal or inner surface 1804 and pressurized air in the chamber 1800 presses against the inner surface 1804. The diaphragm member 1756 further includes an external or outer surface 1806 that is exposed to ambient air pressure in a gap 1810 between the diaphragm member 1756 and a rotatable sealing ring such as a seal sleeve 1812. When pressurized air is provided to the chamber 1800 via the opening 1802, the pressurized air acts upon the inner surface 1804 and produces a force in a radial outer direction 1820 that is greater than the force associated with the atmospheric pressure acting on the outer surface 1806.

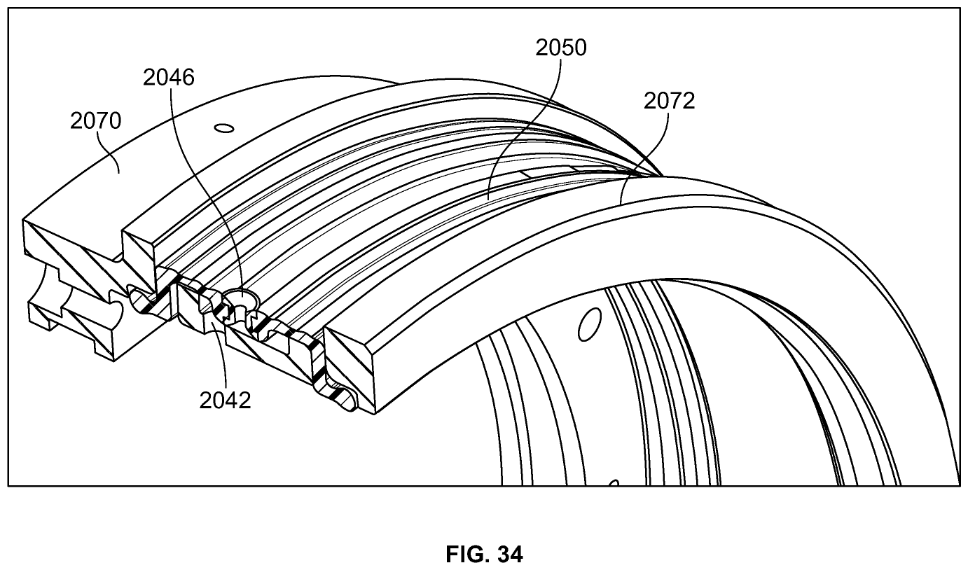

With reference to FIG. 23, the difference in air pressure acting on the inner and outer surfaces 1804, 1806 of the diaphragm member 1756 cause a center, thick portion 1836 of the diaphragm member 1756 to expand radially outward in direction 1820 and bring one or more protrusions thereof, such as center nubs 1832, 1834, into contact with a sealing surface 1830 of the seal sleeve 1812. In one embodiment, the air outlet 1758 is an opening formed in the diaphragm member 1756 or, as an alternative, may be a nozzle embedded in the diaphragm member 1756 (see, e.g., nozzle 2046 in FIG. 34).

In one embodiment, the center nubs 1832, 1834 are annular ridges and cooperate with the annular sealing surface 1830 to define an annulus 1840 between the diaphragm member 1756 and the sealing surface 1830. The engagement between the center nubs 1832, 1834 and the sealing surface 1830 forms an initial seal that permits the air pressure in the chamber 1800 to increase and exert more force against the inner surface 1804 despite the flow rate of pressurized air through the air outlet 1758 decreases.

More specifically, once the center nubs 1832, 1834 have sealed with the sealing surface 1830, all of the pressurized air exiting the air outlet 1758 is directed into the outlet opening 1850 of the seal sleeve 1812 rather than some of the pressurized air escaping to the ambient via gap 1810. The flow rate of the air therefore decreases due to all of the air being directed into the outlet opening 1850. Further, the pressurized air entering the outlet opening 1850 travels into a passageway of a wheel hub supporting the seal sleeve 1812 and into a tire associated with the wheel hub. The tire may have an internal air pressure such that there is resistance to the flow of air into the tire which further decreases the flow rate of air through the outlet 1758. Despite the decrease in air flow rate through the air outlet 1758, the pressure differential between the chamber 1800 and the ambient-air pressure air in the gap 1810 urges the contact portion 1760 toward the sealing surface 1830. Further, the center nubs 1832, 1834 focus the pressure force acting on the inner surface 1804 of the diaphragm member 1756 and keep the diaphragm member 1756 sealingly engaged with the sealing surface 1830 despite the decrease in air flow rate through the air outlet 1758 of the diaphragm member 1756.

Regarding FIG. 23, as the thick portion 1836 balloons outward, the diaphragm member 1756 has wall portions 1860, 1861 that elongate while the base flange portions 1762, 1764 remain secured between the seal sleeve 1754 and the diaphragm support base 1757. The diaphragm seal 1750 is shown in FIG. 23 when the air pressure in the chamber 1800 is 10 pounds per square inch (psi).

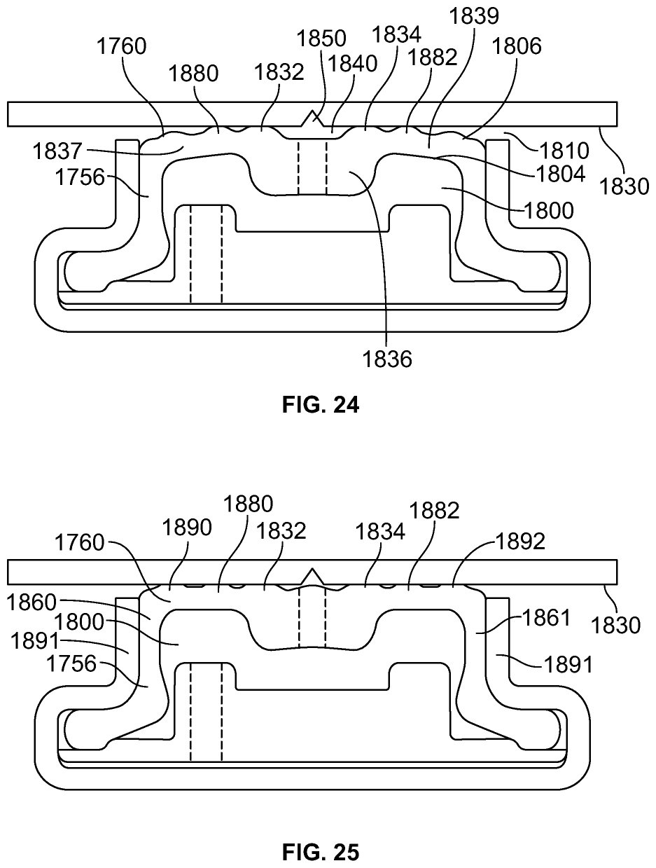

Regarding FIG. 24, the diaphragm member 1756 has thin wall portions 1837, 1839 with intermediate nubs 1880, 1882. In FIG. 24, the pressure in chamber 1800 is increased from the 10 psi of FIG. 23, which brings the intermediate nubs 1880, 1882 into contact with the sealing surface 1830. The intermediate nubs 1880, 1882 may be annular ridges that are similar to the center nubs 1832, 1834. The intermediate nubs 1880, 1882 are movable relative to the center nubs 1880, 1834 since the thin wall portions 1837, 1839 can flex relative to the center, thick portion 1836. The intermediate nubs 1880, 1882 are driven against the sealing surface 1830 by the pressure differential between the chamber 1800 and the ambient air in the gap 1810 once the center nubs 1832, 1834 have engaged the sealing surface 1830 and formed the annulus 1840.

Once the center nubs 1832, 1834 and intermediate nubs 1880, 1882 engage the sealing surface 1830, the air flow rate to the atmospheric pressure air in the gap 1810 may drop to zero due to the engagement between the nubs 1832, 1834, 1880, 1882 and the sealing surface 1830. The absence of airflow to the ambient-pressure air in the gap 1810 reduces the pressure differential across the center, thick portion 1836. However, the nubs 1832, 1834, 1880, 1882 operate as force concentrators to enable the diaphragm member 1756 to continue engaging the sealing surface 1830 when the pressure differential across the center, thick portion 1836 decreases. The nubs 1832, 1834, 1880, 1882 keep the diaphragm member 1756 engaged with the sealing surface 1830 so that pressure can continue to increase in the chamber 1800 and air can be directed into the outlet opening 1850.

Regarding FIG. 25, the chamber 1800 is at 120 psi and has been fully pressurized. The contact portion 1760 of the diaphragm member 1756 includes outer nubs 1890, 1892 that contact the sealing surface 1830. As shown in FIG. 25, all of the nubs 1832, 1834, 1880, 1882, 1890, 1892 are engaged with the sealing surface 1830. The intermediate nubs 1880, 1882 operate to provide sealing contact with the sealing surface 1830 if the center nubs 1832, 1834 fail. Further, the outer nubs 1890, 1892 operate as a secondary backup in the event that the center nubs 1832, 1834 and intermediate nubs 1880, 1882 fail. The radial walls 1860, 1861 of the diaphragm member 1756 are pressed against radial wall portions 1891, 1893 of the seal sleeve 1754. The radial wall portions 1891, 1893 direct the expansion of the diaphragm member 1756 radially outward such that the contact portion 1760 of the diaphragm member 1756 moves as an expanding ring that engages the inner diameter of the sealing surface 1830 when compressed air is applied to the chamber 1800.

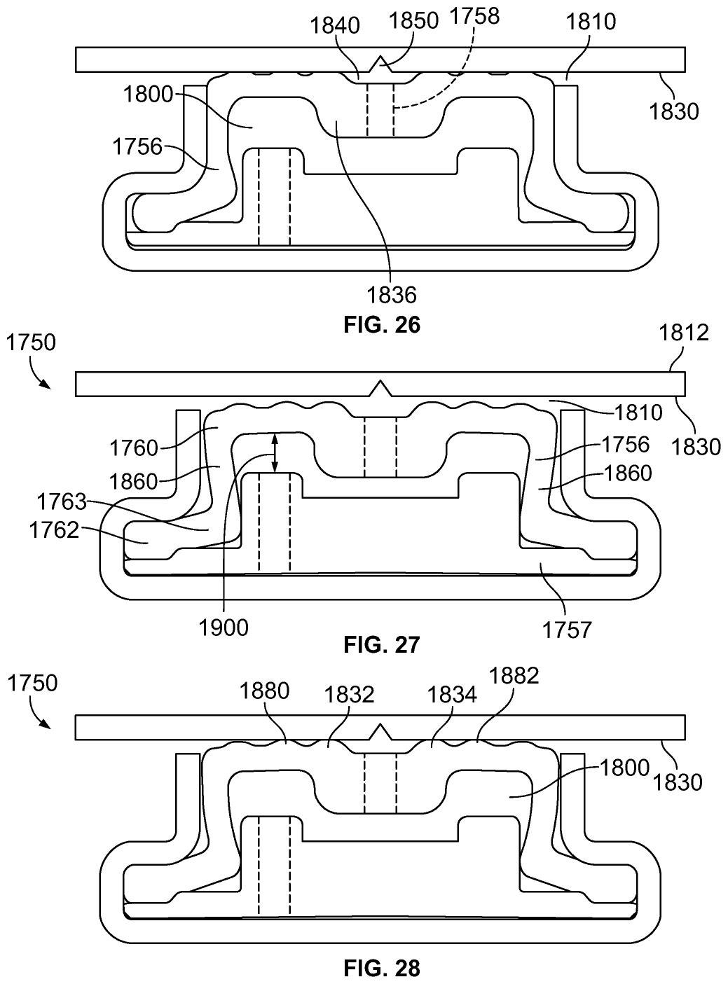

Regarding FIG. 26, the chamber 1800 is at 120 PSI. However, the pressure in the tire and outlet opening 1850 are also at 120 PSI, such as once the tire has reached the predetermined fill pressure. There is no longer a pressure differential across the air outlet 1758. The thick portion 1836 of the diaphragm member 1756 shifts radially inward slightly away from the sealing surface 1830 and the annulus 1840 enlarges due to the balanced air pressure on either side of the thick portion 1836. When the pressure differential across the air outlet 1758 drops to zero, the center nubs 1832, 1834 of the thick portion 1836 have a reduced pressure force urging the center nubs 1832, 1834 against the sealing surface 1830. In the configuration of FIG. 26, the thin wall portions 1837, 1839 still have a pressure differential thereacross since the pressure in the chamber 1800 is greater than the ambient air pressure in the gap 1810. The pressure differential across the thin wall portions 1837, 1839 provides a pressure force that continues to urge the intermediate nubs 1880, 1882 against the sealing surface 1830. In this manner, the intermediate nubs 1880, 1882 operate as the primary sealing members once the pressure differential across the air outlet 1758 approaches zero.

Regarding FIG. 27, the diaphragm seal 1750 is shown at an elevated 300° F. temperature and with the chamber 1800 at ambient air pressure to show how the diaphragm member 1756 undergoes thermal expansion at elevated temperatures. The radial wall portions 1860, 1861 of the diaphragm member 1756 elongate, the base flange portions 1762, 1764 may widen such that bends 1763, 1765 thereof contact the diaphragm support base 1757.

In FIG. 27, the contact portion 1760 is spaced a distance 1900 that is greater than a distance 1902 in FIG. 22 due to the higher temperature of the diaphragm member 1756 in FIG. 27. Although the diaphragm member 1756 is thermally expanded in FIG. 27, the diaphragm seal 1750 still has a gap 1810 between the diaphragm member 1756 and the sealing surface 1830. In this manner, the sealing surface 1830 may rotate about a stationary diaphragm member 1756 during movement of the associated vehicle without producing friction forces against the diaphragm member 1756.

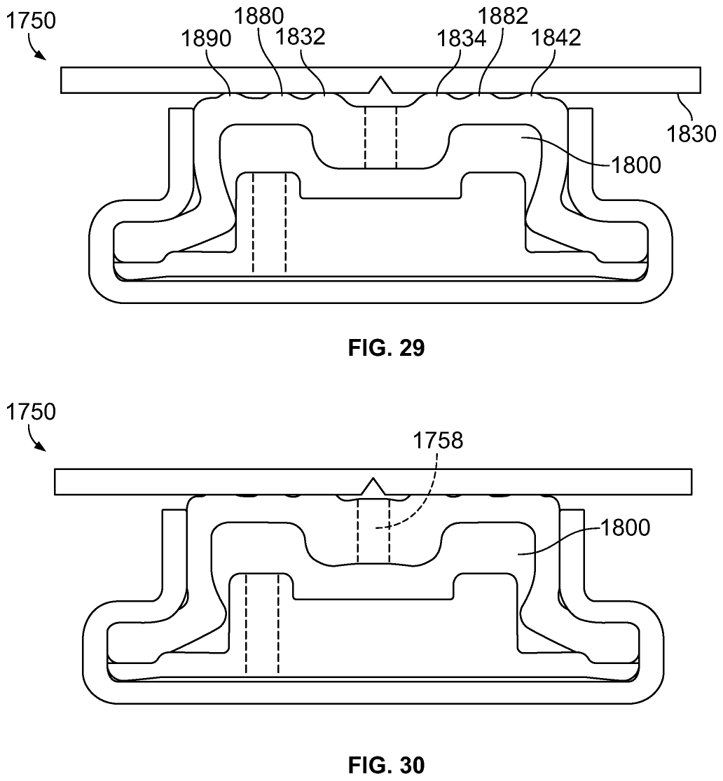

FIG. 28 shows pressurized air having been applied to the diaphragm seal 1750 at the temperature of 300° F., with the chamber 1800 at an internal pressure of 10 psi. In FIG. 28, the center nubs 1832, 1834 as well as the intermediate nubs 1880, 1882 are engaged with the sealing surface. The engagement of the intermediate nubs 1880, 1882 at the internal pressure of 10 psi occurs at a lower pressure than if the diaphragm seal 1750 were at 70° F. (see FIG. 23) due to the thermal expansion of the diaphragm member 1756. With reference to FIG. 29, the air pressure in the chamber 1800 at a pressure higher than in FIG. 28 and all of the nubs 1832, 1834, 1880, 1882, 1890, 1892 engaging the sealing surface 1830.

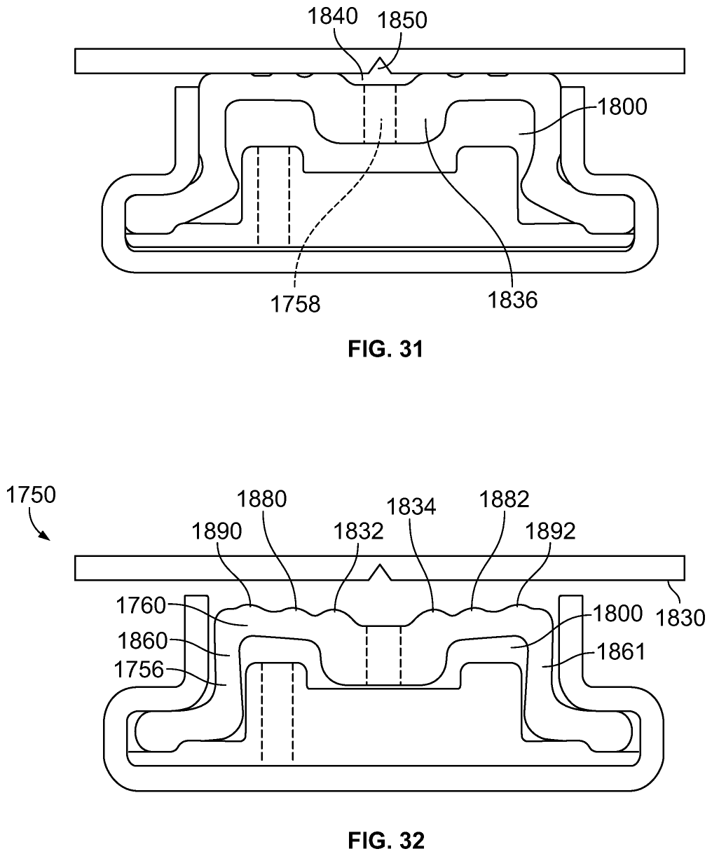

Regarding FIG. 30, the diaphragm seal 1750 is shown upon the chamber 1800 reaching an internal pressure of 120 psi but air continues to flow through the air outlet 1758. In FIG. 31, the chamber 1800 is at 120 psi, but the pressure in the tire and the outlet opening 1850 are also at 120 psi so that there is no pressure differential across the air outlet 1758 and the thick portion 1836 shifts radially inward slightly from the position in FIG. 30 which increases a radial height of the annulus 1840.

Regarding FIG. 32, the diaphragm seal 1750 is shown at a temperature of −40° F. and when the chamber 1800 is at ambient air pressure. The diaphragm member 1756 thermally contracts due to the low temperature, such that the radial wall portions 1860, 1861 may have shortened and the contact portion 1760 has a generally concave shape. When pressure air is directed into the chamber 1800, the nubs 1832, 1834, 1880, 1882 will engage the sealing surface 1830 but the nubs 1890, 1892 may not contact the sealing surface 1830 even at maximum pressure due to the stiffness of the diaphragm member 1756. The diaphragm member 1756 is able to establish and maintain a seal with the sealing surface 1830 via the pressure force concentration provided by the nubs 1832, 1834, 1880, 1882 despite the nubs 1890, 1892 not contacting the sealing surface 1830.

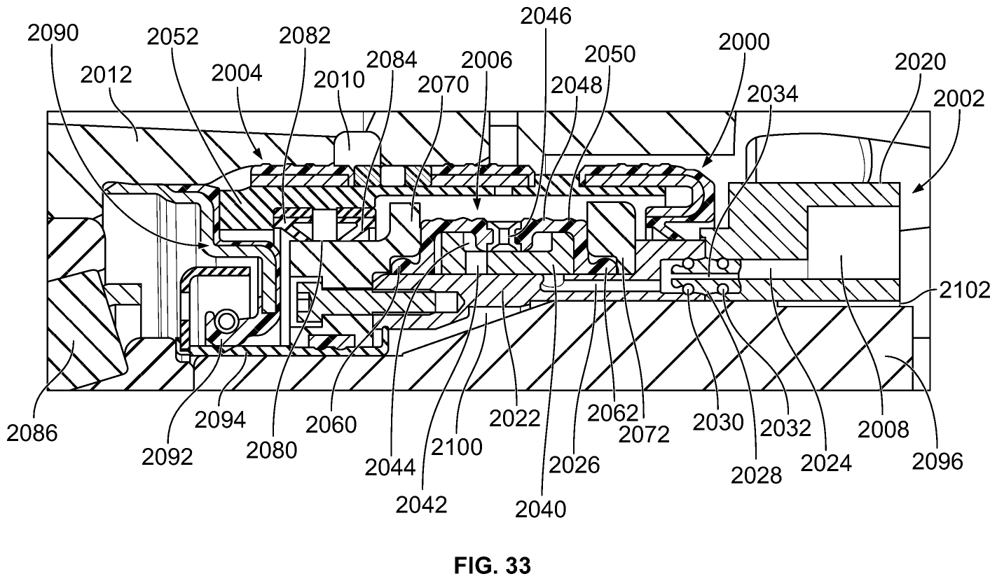

Regarding FIG. 33, an air seal cartridge 2000 is provided that is similar in many respects to the air seal cartridges discussed above. The air seal cartridge 2000 includes a non-rotatable pressurized air receiver 2002, a rotatable pressurized air distributor 2004, and a diaphragm seal 2006 that may be engaged to permit air received at an air inlet 2008 of the non-rotatable pressurized air receiver 2002 to flow into an inlet port 2010 of a wheel hub 2012 to increase air pressure in a tire associated with the wheel hub 2012. The non-rotatable pressurized air receiver 2002 includes a body 2020 and a mount 2022 that is connected thereto. The body 2020 has a passageway 2024 that communicates with a passageway 2026 of the mount 2024 via a pin 2028. The pin 2028 has o-rings 2030, 2032 to form an airtight connection between the body 2020 and the mount 2022 and a throughbore 2034. Pressurized air provided to the air inlet 2008 travels through the passageways 2024, 2034, 2026, below a diaphragm support base 2040, through an opening 2044 of the diaphragm support base 2040, into a chamber 2044, and through a nozzle 2046 of a diaphragm 2048 of the diaphragm seal 2006.

The diaphragm 2048 includes a diaphragm member 2050 that sealingly engages a seal sleeve 2052 mounted to the wheel hub 2012 upon the chamber 2044 being pressurized. The diaphragm member 2050 has base flange portions 2060, 2062 that are captured radially between the mount 2022, an outboard diaphragm support ring 2070, and an inboard diaphragm support ring 2072. Regarding FIG. 34, the nozzle 2046 may be made of a metal or plastic material that is secured to the diaphragm member 2050, such as being molded into the diaphragm member 2050.

Returning to FIG. 33, the outboard diaphragm support ring 2070 has a radially outer running surface 2080 and the rotatable pressurized air distributor 2004 includes seals 2082, 2084 that engage the running surface 2080 to restrict the flow of lubricant and debris. The air seal cartridge 2000 further includes a seal case 2090 mounted to the wheel hub 2012 with a lip seal 2092 that engages a mounting sleeve 2094 connected to the mount 2022 and secured to a spindle 2096. The air seal cartridge 2000 and spindle 2096 have a passageway 2100 therebetween to permit lubricant to escape in the event of failure of the lip seal 2092.

Uses of singular terms such as “a,” “an,” are intended to cover both the singular and the plural, unless otherwise indicated herein or clearly contradicted by context. For example, a reference to a sensor detecting a parameter is intended to encompass one or more sensors detecting one or more parameters. The terms “comprising,” “having,” “including,” and “containing” are to be construed as open-ended terms. It is intended that the phrase “at least one of” as used herein be interpreted in the disjunctive sense. For example, the phrase “at least one of A and B” is intended to encompass A, B, or both A and B.

While there have been illustrated and described particular embodiments of the present invention, it will be appreciated that numerous changes and modifications will occur to those skilled in the art, and it is intended for the present invention to cover all those changes and modifications which fall within the scope of the appended claims.

1. A rotary union for a wheel end system including a wheel hub having a passageway, the rotary union comprising:
a pressurized air receiver configured to be mounted to a vehicle spindle;
an air inlet of the pressurized air receiver;
a pressurized air distributor rotatable around an axis relative to the pressurized air receiver, the pressurized air distributor configured to be mounted to the wheel hub and rotate therewith;
an air outlet of the pressurized air distributor to direct pressurized air toward the passageway of the wheel hub;
a seal of the pressurized air receiver and the pressurized air distributor axially spaced from the air inlet of the pressurized air receiver so that the seal and air inlet are offset from one another along the vehicle spindle with the pressurized air receiver mounted to the vehicle spindle and the pressurized air distributor mounted to the wheel hub; and
the seal shiftable from a disengaged configuration to an engaged configuration to permit pressurized air received at the air inlet of the pressurized air receiver to flow to the air outlet of the pressurized air distributor.

2. The rotary union of claim 1 wherein the pressurized air receiver includes a pressurized air receiver passageway connecting the seal and the air inlet, the pressurized air receiver passageway oriented to extend along the vehicle spindle with the pressurized air receiver mounted to the vehicle spindle.

3. The rotary union of claim 1 wherein the pressurized air receiver includes an annular body comprising the air inlet, the annular body having a central opening sized to receive the vehicle spindle.

4. The rotary union of claim 1 wherein the pressurized air distributor includes a sealing member having an opening defining at least a portion of the air outlet of the pressurized air distributor, the sealing member configured to engage a radially inner surface of the wheel hub.

5. The rotary union of claim 4 wherein the pressurized air distributor includes a rotatable sealing ring radially inward of the sealing member; and
wherein the seal includes a non-rotatable sealing member of the pressurized air receiver that tightly engages the rotatable sealing ring with the seal in the engaged configuration and less tightly engages the rotatable sealing ring with the seal in the disengaged configuration.

6. The rotary union of claim 1 further comprising a bearing seal assembly comprising:
a non-rotatable sleeve connected to the pressurized air receiver and configured to be mounted to the vehicle spindle;
a rotatable sleeve connected to the pressurized air distributor and configured to be mounted to the wheel hub, the rotatable sleeve rotatable relative to the non-rotatable sleeve upon rotation of the pressurized air distributor relative to the pressurized air receiver; and
a sealing member of one of the non-rotatable sleeve and the rotatable sleeve that engages a surface of the other of the non-rotatable sleeve and the rotatable sleeve as the rotatable sleeve rotates relative to the non-rotatable sleeve.

7. The rotary union of claim 1 wherein the seal is configured to shift from the disengaged configuration to the engaged configuration upon the air inlet receiving pressurized air.

8. The rotary union of claim 1 wherein the pressurized air distributor includes a sealing ring; and
wherein the pressurized air receiver includes a sealing member, the sealing member tightly engaging the sealing ring with the seal in the engaged configuration and engaging the sealing ring less tightly with the seal in the disengaged configuration.

9. The rotary union of claim 1 wherein the seal comprises a diaphragm seal.

10. The rotary union of claim 1 wherein the seal comprises a face seal.

11. The rotary union of claim 1 wherein the seal comprises a lip seal.

12. The rotary union of claim 1 wherein the pressurized air receiver includes an annular body with a radially inner channel configured to direct a lubricant and/or pressurized air along a radially outer surface of the spindle upon a failure of the seal.

13. The rotary union of claim 1 wherein the pressurized air distributor includes an annular body with a radially outer channel configured to direct lubricant along a radially inner surface of the wheel hub.

14. The rotary union of claim 1 in combination with the wheel hub, the wheel hub comprising a unitary, one-piece wheel hub body having a central opening and an annular inner surface extending thereabout;
wherein the pressurized air distributor includes a radially outer portion configured to engage the annular inner surface of the wheel hub body.

15. The rotary union of claim 1 wherein the pressurized air receiver is configured to direct pressurized air received at the air inlet along a path outside of and along the spindle between the wheel hub and the spindle.

16. The rotary union of claim 1 wherein the seal includes sealing portions of the pressurized air receiver and the pressurized air distributor, the sealing portions spaced apart with the seal in the disengaged configuration and the sealing portions contacting one another with the seal in the engaged configuration.

17. The rotary union of claim 1 wherein the seal includes sealing portions of the pressurized air receiver and the pressurized air distributor, the sealing portions in contact with one another with the seal in the disengaged configuration and the sealing portions more firmly contacting one another with the seal in the engaged configuration than in the disengaged configuration.

18. A wheel hub comprising:
a wheel hub body including a wheel mounting portion;
inboard and outboard bearings to rotatably mount the wheel hub body to a vehicle spindle,
a pressurized air passageway associated with the wheel hub body and rotatable therewith about the vehicle spindle;
a rotary union inboard of the inboard bearing and including an air inlet to receive pressurized air and an air outlet to direct the pressurized air toward the pressurized air passageway, the air outlet rotatable with the wheel hub body about the vehicle spindle; and
a seal of the rotary union operable to pneumatically connect and disconnect the air inlet and the air outlet of the rotary union.

19. The wheel hub of claim 18 wherein the seal pneumatically connects the air inlet and the air outlet upon application of pressurized air to the air inlet of the rotary union and pneumatically disconnects the air inlet and the air outlet upon pressurized air not being applied to the air inlet of the rotary union.

20. The wheel hub of claim 18 wherein the pressurized air passageway includes a pressurized air inlet port inboard of the inboard bearing and a pressurized air outlet port outboard of the inboard bearing.

21. The wheel hub of claim 18 wherein the mounting portion of the wheel hub includes a mounting flange;
wherein the pressurized air passageway includes a pressurized air inlet port inboard of the mounting flange and a pressurized air outlet port outboard of the mounting flange.

22. The wheel hub of claim 18 wherein the air inlet of the rotary union is inboard of the wheel hub.

23. The wheel hub of claim 18 wherein the rotary union includes an annular body having a central opening to receive the vehicle spindle, the annular body including the air inlet.

24. The wheel hub of claim 18 further comprising a lubricant seal assembly intermediate the inboard bearing and the rotary union.

25. The wheel hub of claim 18 wherein the rotary union includes a non-rotatable body configured to be mounted to the spindle;
a mounting ring secured to the non-rotatable body intermediate the non-rotatable body and the inboard bearing; and
a seal case mounted to the wheel hub having a sealing member that engages the mounting ring to inhibit lubricant from traveling in an inboard direction from the inboard bearing toward the rotary union.

26. The wheel hub of claim 18 wherein the rotary union includes an annular body having a radially inner channel that faces the spindle to permit lubricant and/or air to flow through the channel and along the spindle upon a failure of the seal.

27. The wheel hub of claim 18 further comprising a lubricant seal intermediate the inboard bearing and the rotary union; and
wherein the rotary union includes an annular member mounted to the wheel hub, the annular member having a radially outer channel that faces the wheel hub body and permits lubricant to flow through the radially outer channel upon a failure of the lubricant seal.

28. The wheel hub of claim 18 wherein the rotary union comprises a non-rotatable pressurized air receiver mounting ring having a central opening to receive the spindle and a rotatable pressurized air distributor mounting ring extending about the non-rotatable pressurized air receiver mounting ring; and
wherein the seal includes a rotatable sealing portion supported by the rotatable pressurized air distributor mounting ring and a non-rotatable sealing portion supported by the non-rotatable pressurized receiver mounting ring; and
wherein the non-rotatable sealing portion is urged tightly against the rotatable sealing portion in response to the air inlet of the rotary union receiving pressurized air.

29. The wheel hub of claim 18 wherein the rotary union comprises an annular, non-rotatable pressurized air receiver having a central opening to receive the vehicle spindle and an annular, rotatable pressurized air distributor;
wherein the rotatable pressurized air distributor has a radially outer surface frictionally engaged with a radially inner surface of the wheel hub body; and
a spindle nut configured to be connected to the vehicle spindle and maintain the non-rotatable pressurized air receiver on the spindle.

30. The wheel hub of claim 18 wherein the wheel hub body includes a central opening to receive the vehicle spindle, an interior surface defining at least a portion of the central opening, and an exterior surface opposite the interior surface; and
wherein the pressurized air passageway extends from the interior surface to the exterior surface.

31. The wheel hub of claim 18 wherein the seal includes:
a diaphragm seal;
a face seal; or
a lip seal.

32. The wheel hub of claim 18 wherein the seal includes sealing portions configured to shift together upon application of pressurized air to the air inlet of the rotary union and shift apart upon pressurized air not being applied to the air inlet.

33. The wheel hub of claim 18 wherein the wheel hub body has a unitary, one-piece construction.

34. The wheel hub of claim 18 wherein the seal includes sealing portions that are spaced apart with the air inlet and the air outlet pneumatically disconnected, the sealing portions in contact with one another with the air inlet and the air outlet pneumatically connected.

35. The wheel hub of claim 18 wherein the seal includes sealing portions that contact one another with the air inlet and the air outlet pneumatically disconnected, the sealing portions more tightly contacting one another with the air inlet and the air outlet pneumatically connected than when the air inlet and the air outlet are pneumatically disconnected.

36-47. (canceled)
